(19) United States
(12) Patent Application Publication
(10) Pub. No.: US 2013/0114135 A1
(43) Pub. Date: May 9, 2013

(54) METHOD OF DISPLAYING 3D IMAGE

(71) Applicant: MING-YEN LIN, Taipei City (TW)

(72) Inventor: MING-YEN LIN, Taipei City (TW)

(73) Assignee: UNIQUE INSTRUMENTS CO. LTD, Taipei City (TW)

(21) Appl. No.: 13/427,126

(22) Filed: Mar. 22, 2012

(30) Foreign Application Priority Data
Nov. 8, 2011 (TW) 100140729

(51) Int. Cl. G02B 27/22

(52) U.S. Cl. 359/464

(57) ABSTRACT

A method of displaying a 3D image is provided, which mainly proposes a real-time detection method of a viewing position, an optimum alignment method of a viewing position and a view, a dynamic multi-view 3D image combination method, and a design method of a static parallax barrier device, to eliminate defects of auto-stereoscopic display especially in the case that a common flat-panel display screen and a static parallax barrier device are used to display a 3D image, so as to effectively solve problems of a ghost image, a pseudo stereoscopic image, and insufficient viewing freedom in horizontal and vertical directions on an optimum viewable plane, thereby achieving the objectives of greatly improving the 3D image quality and the convenience of use.

### BACKGROUND OF THE INVENTION

1. Field of Invention

The present invention relates to a method of displaying a 3D image, which mainly proposes a real-time detection method of a viewing position, an optimum alignment method of a viewing position and a view, a dynamic multi-view 3D image combination method and a design method of a static parallax barrier device, to eliminate defects of auto-stereoscopic display especially in the case that a common flat-panel display screen and a static parallax barrier device are used to display a 3D image, so as to effectively solve problems of a ghost image, a pseudo stereoscopic image, and insufficient viewing freedom in horizontal and vertical directions on an optimum viewable plane, thereby achieving the objectives of greatly improving the 3D image quality and the convenience of use.

2. Related Art

In a method of displaying a multi-view 3D image disclosed in ROC Patent Application No. 100114446, for display of a multi-view auto-stereoscopic image, a multi-view 3D image combination method and an optimized design of a slantwise strip parallax barrier are mainly proposed, so as to provide a plurality of optimum viewing points with fixed positions on an optimum viewing distance and achieve the objective of respectively presenting a single view image at the optimum viewing points. As the slantwise strip parallax barrier has a fixed structure (referred to as a “static parallax barrier device” hereinafter) and the multi-view 3D image combination method is a fixed combination procedure (referred to as a “static multi-view 3D image combination method” hereinafter), at the single optimum viewing point, only a single and fixed view image can be presented. The objective of increasing the degree of horizontal viewing freedom can be achieved by reducing the aperture width of a transparent component. However, when the aperture width is reduced, the brightness of the image decreases, and as the increased degree of horizontal viewing freedom is limited, great changes of the viewing position cannot be handled. That is, in the horizontal direction, when a viewing position of a viewer departs from the optimum viewing point and exceeds an allowable horizontal viewing range, the viewer views the ghost image or a pseudo stereoscopic image with left and right images inverted, eventually resulting in rather inconvenience of use. In addition, for the vertical viewing freedom with the same phenomenon, no discussion or improvement has been made.

### SUMMARY OF THE INVENTION

To eliminate the defects in the prior art, and especially to eliminate the defects in presenting a 3D image by using a static parallax barrier device and a static multi-view 3D image combination method, the present invention mainly proposes a design method of a static parallax barrier device and a dynamic multi-view 3D image combination method in combination with a real-time detection method of a viewing position and an optimum alignment method of a viewing position and a view, to effectively solve problems of a ghost image, a pseudo stereoscopic image, and insufficient viewing freedom in horizontal and vertical directions on an optimum viewable plane, thereby achieving the objectives of greatly improving the 3D image quality and the convenience of use.

### BRIEF DESCRIPTION OF THE DRAWINGS

The present invention will become more fully understood from the detailed description given herein below for illustration only, and thus are not limitative of the present invention, and wherein:

FIG. 1 is a schematic view of a flat-panel display screen having R, G, and B sub-pixels in horizontal strip configuration;

FIG. 2 to FIG. 9 are various multi-view combined 3D images having the right slantwise feature;

FIG. 10 is a multi-view combined 3D image without the slantwise feature;

FIG. 11 is a multi-view combined 3D image having the left slantwise feature;

FIG. 12 is a schematic view of a structure of a 2-view slantwise strip parallax barrier;

FIG. 13 is a schematic view of distribution of optimum viewing points on an optimum viewing plane;

FIG. 14 is a schematic view of the principle of displaying a 2-view combined 3D image;

FIG. 15 is a schematic view of the definitions of i and j in an optimum viewing point P_{k,i,j}(x_{c},y_{c},Z₀) when n=2, m=3, and k=0;

FIG. 16 shows coordinates of each horizontal optimum viewing point when n=2, m=3, and k=0;

FIG. 17 is a schematic view of the definitions of i and j in an optimum viewing point P_{k,i,j}(x_{c},y_{c},Z₀) when n=4, m=3, and k=0;

FIG. 18 shows coordinates of each horizontal optimum viewing point when n=4, m=3, and k=0;

FIG. 19 is a schematic view of the relation between ΔB_{H} and ΔX_{VF} when ΔB_{H}=B_{H}/2;

FIG. 20 is a schematic view of the relation between ΔB_{H} and ΔX_{VF} when ΔB_{H}=2B_{H}/3;

FIG. 21 to FIG. 26 are schematic views of various multi-view combined 3D images;

FIG. 27 is a schematic view of an optical effect of a 2-view slantwise strip parallax barrier in the vertical direction;

FIG. 28 is a schematic view of the relation between ΔB_{V} and ΔY_{VF} when ΔB_{V}=B_{V}/2;

FIG. 29 is a schematic view of the relation between ΔB_{V} and ΔY_{VF} when ΔB_{V}=2B_{V}/3;

FIG. 30 is a schematic view of an optimum viewing point having the feature of allowable horizontal and vertical viewing ranges;

FIG. 31 is a schematic view of an allowable viewing range and a ghost image zone having the distribution feature of a slant angle θ;

FIG. 32 to FIG. 37 are schematic views of 2-view combined 3D images having different values of Δ;

FIG. 38 to FIG. 43 are schematic views of the relation between A and P_{k,i,j}(x_{c},y_{c},Z₀);

FIG. 44 is a schematic view of positions of a central line and boundary lines when Δ=0;

FIG. 45 is a schematic view of position changes of a central line and boundary lines when Δ=1;

FIG. 46 is a schematic view of overlapping processing of the positions of the central lines and the boundary lines when Δ=0 and Δ=1;

FIG. 47 to FIG. 48 are schematic views of a 3D camera structure and coordinates of the position of the device;

FIG. 49 is a schematic view of a 3D camera device;

FIG. 50 to FIG. 52 are schematic views of settings of an optimum viewing condition;

FIG. 53 is a schematic view of Y_{i,j,Δ}(x,y) when Δ=0, 1, and 2;

FIG. 54 is a schematic view of Y_{i,j,Δ}(x,y) when Δ=0, −1, and −2;

FIG. 55 is a graph of coordinate values x(i,j,Δ) of intersection points between Y_{i,j,Δ}(x,y) and an X-axis calculated when Δ=0, 1, and 2 and Δ=−0, −1, and −2;

FIG. 56 is a graph of position changes of a primary optimum viewing point x(i=0,j=0,Δ=0) in the condition of |Δ|≦m;

FIG. 57 is a schematic view of slant lines L_{L} and L_{R} passing through the positions of the left and right eyes (x_{L},y_{L},z_{L}) and (x_{R},y_{R},z_{R});

FIG. 58 is a schematic view of the structure of an optimum viewable plane;

FIG. 59 is a schematic view of the largest horizontal viewing zone number corresponding to the optimum viewable plane;

FIG. 60 is a schematic view of the largest vertical viewing zone number corresponding to the optimum viewable plane;

FIG. 61 is a schematic view of the structure of x(i,j,Δ) for a 2-view display (n=2 and m=3) and in the condition of a viewing zone with i=0 and j=0;

FIG. 62 is a schematic view of the structure of x(i,j,Δ) for a 4-view display (n=4 and m=3) and in the condition of viewing zones with i=0 and j=0, and i=1 and j=0;

FIG. 63 is a schematic view of the structure of x(i,j,Δ) for a 4-view display (n=4 and m=3) and in the condition of a viewing zone of i=0 and j=2; and

FIG. 64 is a schematic view according to an embodiment of the present invention.

### DETAILED DESCRIPTION OF THE INVENTION

1. Design Method of a Static Parallax Barrier Device

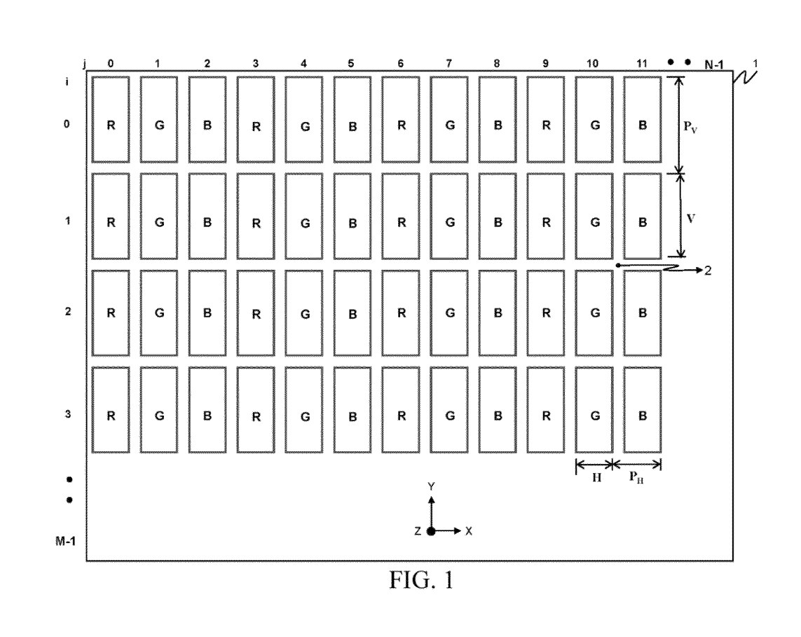

FIG. 1 is a schematic view of a regular flat-panel display screen having R, G, and B sub-pixels arranged in horizontal strip configuration. The flat-panel display screen 1 is a liquid crystal screen, plasma screen, or organic light emitting diode (OLED) screen, which is formed of N×M R, G, and B sub-pixels and has a feature of horizontal strip configuration. N is a total number of sub-pixels in a horizontal direction (X-axis) of the display screen, and M is a total number of sub-pixels in a vertical direction (Y-axis) of the display screen. j and i are the indexes of the horizontal position and the vertical position of a single sub-pixel respectively, where 0≦j≦N−1 and 0≦i≦M−1. The single sub-pixel has a size of P_{H}×P_{V}, where P_{H} is the horizontal width of a sub-pixel and P_{V} is the vertical height of a sub-pixel. By subtracting a black space 2 between sub-pixels (which is usually formed of a non-luminous material and is black, for example, which is formed of black photoresist on a liquid crystal display panel and referred to as a black matrix), the effective luminous size of a single sub-pixel is H×V. The so-called horizontal strip configuration means that on any arbitrary horizontal scan line, the R, G, and B sub-pixels are arranged in a sequence of R, G, and B in a horizontal direction to form a strip structure with color distribution; while in a vertical direction, sub-pixels of the same color form a single-color strip structure. For the illustration below, a coordinate system XYZ is defined. An X-axis of the coordinate system is set at a horizontal direction, a Y-axis is set at a vertical direction, and a Z-axis is set at a direction perpendicular to the direction of the display screen 1, and the directions of the three axes follow the Right-hand rule. In addition, the origin of the coordinate system XYZ is set at a center of the screen. The coordinate system XYZ is referred to as the screen coordinate system below.

When a flat-panel display having R, G, and B sub-pixels in horizontal strip configuration is used to display a 3D image, according to the above mentioned patent, a multi-view image is formed of n (n≧2) single view images Vₖ. Therefore, n is a total view number. In addition, the single view image Vₖ is defined as follows:

$${V}_{k} = {\sum }_{i = 0}^{M - 1} {\sum }_{j = 0}^{N - 1} {V}_{k}^{i , j} , \qquad ( 1 )$$

where M, N, i, and j are as defined above, k is the view number, and 0≦k<n; Vₖ^{i,j} is the sub-pixel image data at a position (i,j) in the single view image Vₖ. In addition, when a display screen (not shown) having R, G, and B sub-pixels in vertical strip configuration, mosaic configuration or delta configuration is used to display a multi-view image, the formula (1) is also applicable, referring to ROC Patent Applications No. 099127429 and No. 099134699. Definitely, for the Pentile configuration (not shown, having RGBW, in which W is white) developed for the power-saving purpose, the single view image Vₖ may also be defined through the formula (1). In the present invention, only the display screen in the horizontal strip configuration is taken as an example to illustrate the efficacy of the present invention. Therefore, the illustration is no longer repeated. The multi-view combined 3D image Σₙ is generated through the operation with the following formula:

$${\sum }_{n} {\sum }_{i = 0}^{M - 1} {\sum }_{j = 0}^{N - 1} {V}_{Λ}^{i , j} , \qquad ( 2 )$$

where Λ is the view number, which is generated according to the operation of the following formula:

$$Λ = Mod [ int ( \frac{j - Π \times int ( \frac{i + Δ}{Q} )}{m} ) , n ] , \qquad ( 3 )$$

where Λ<n, n is the total view number; m is the number of sub-pixels in a horizontal smallest display unit; Q is the number of sub-pixels in a vertical smallest display unit; Δ is the horizontal displacement phase; and Π is the horizontal displacement amplitude. In addition, int is a function of rounding, and Mod is a function of taking a remainder. The so-called horizontal and vertical smallest display units refer to the smallest unit of the view image that can be viewed through an aperture of a single transparent component of the parallax barrier. In addition, when a display screen (not shown) having R, G, and B sub-pixels in mosaic configuration, delta configuration or Pentile configuration is used to display a multi-view image, the formula (3) is also applicable, referring to ROC Patent Applications No. 099127429 and No. 099134699. In the present invention, only the display screen in the horizontal strip configuration is taken as an example to illustrate the efficacy of the present invention. Therefore, the illustration is no longer repeated. Definitely, the multi-view combined 3D image Σₙ obtained by the formula (3) has the right slantwise feature. The combination of the image having the left slantwise feature is represented by the following formula (referring to Patents No. 099127429 and No. 099134699):

$$Λ = Mod [ int ( \frac{( N - 1 ) - j - Π \times int ( \frac{i + Δ}{Q} )}{m} ) , n ] , \qquad ( 4 )$$

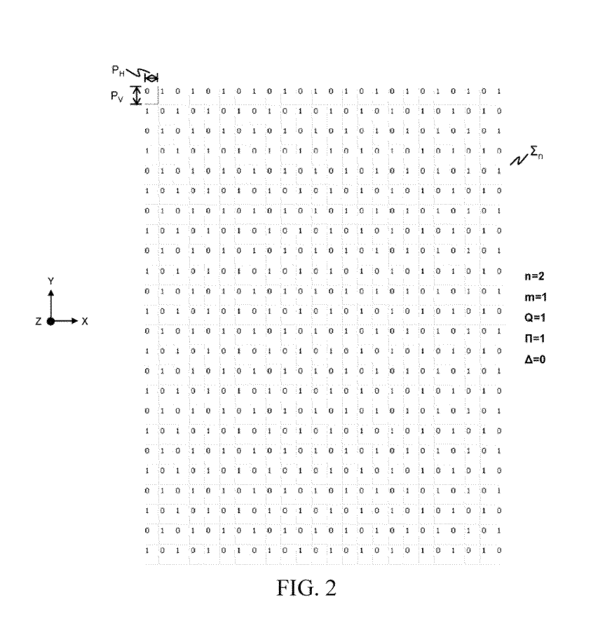

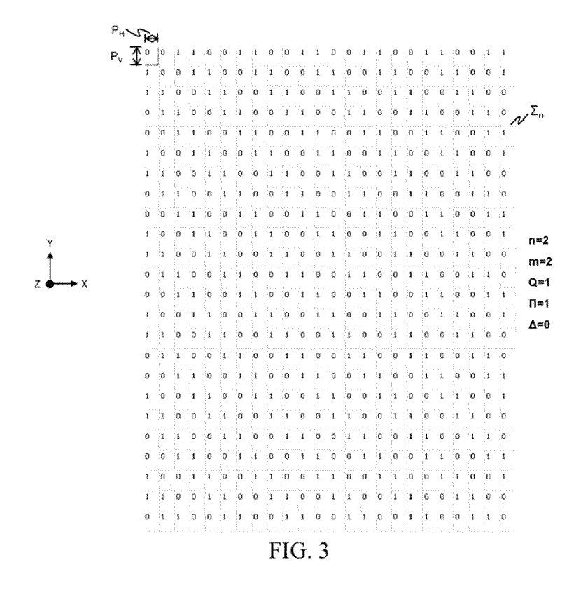

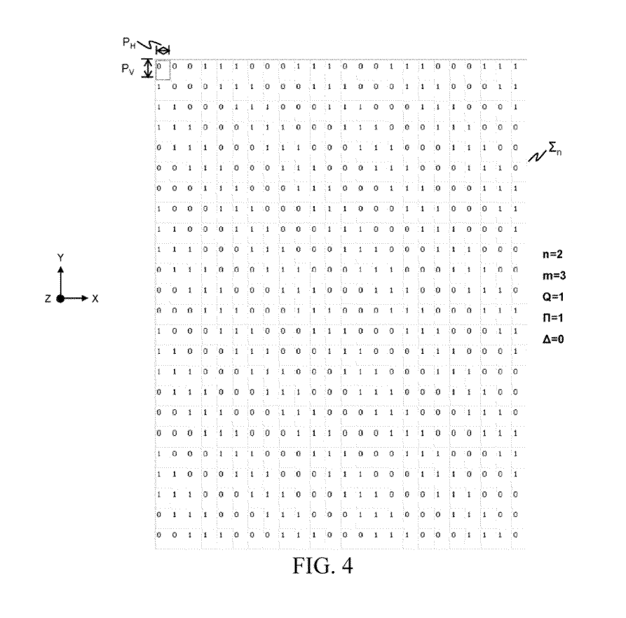

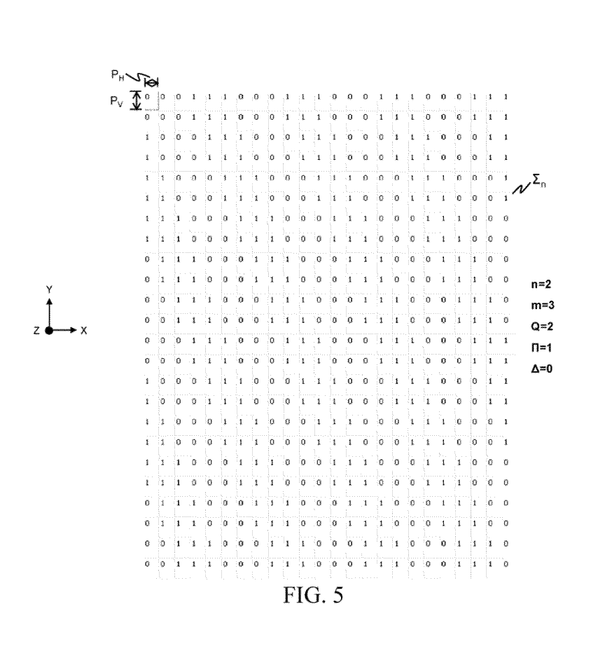

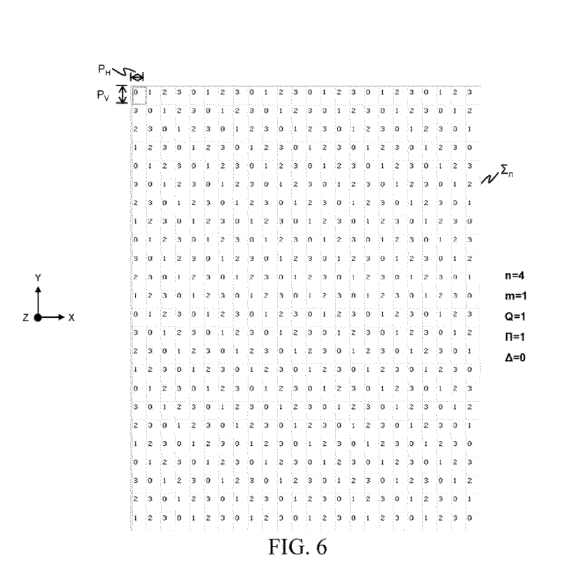

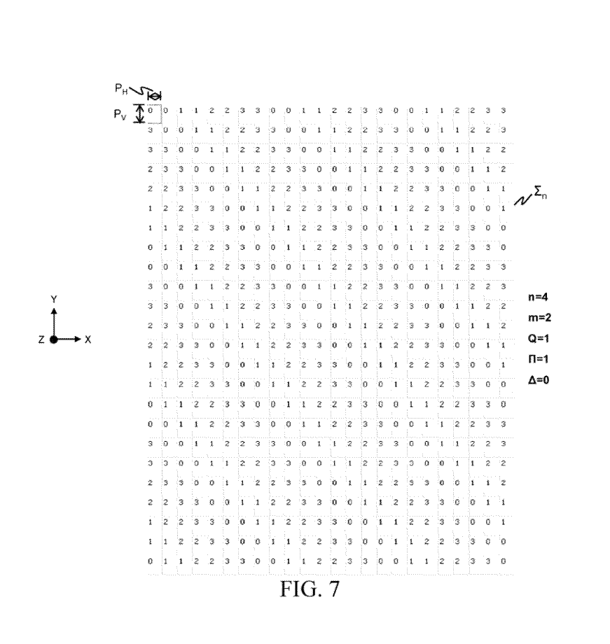

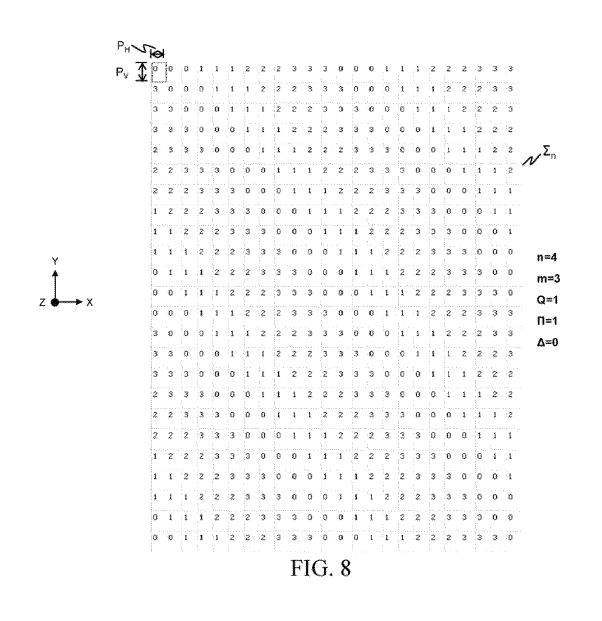

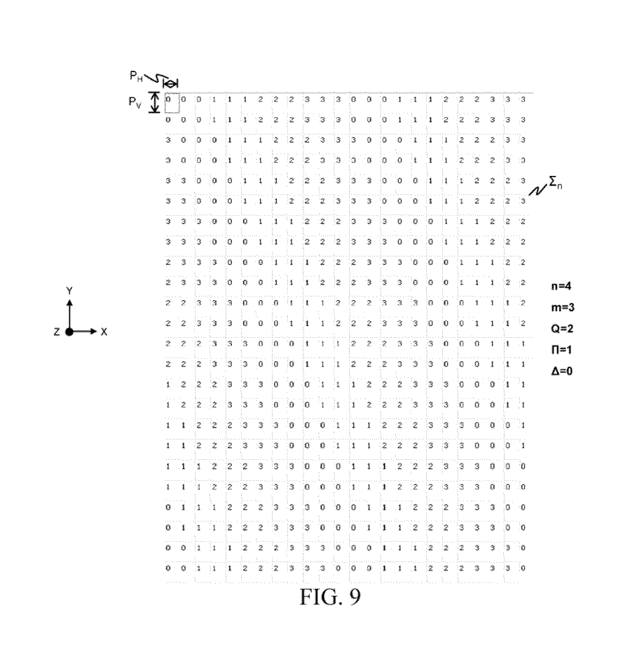

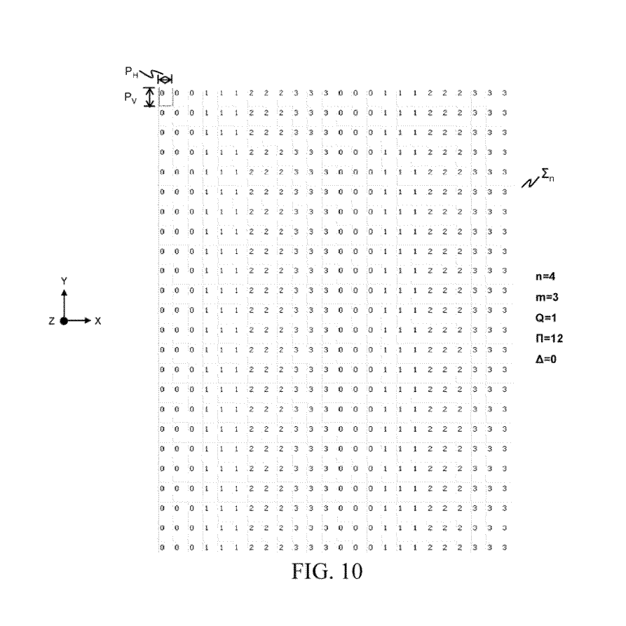

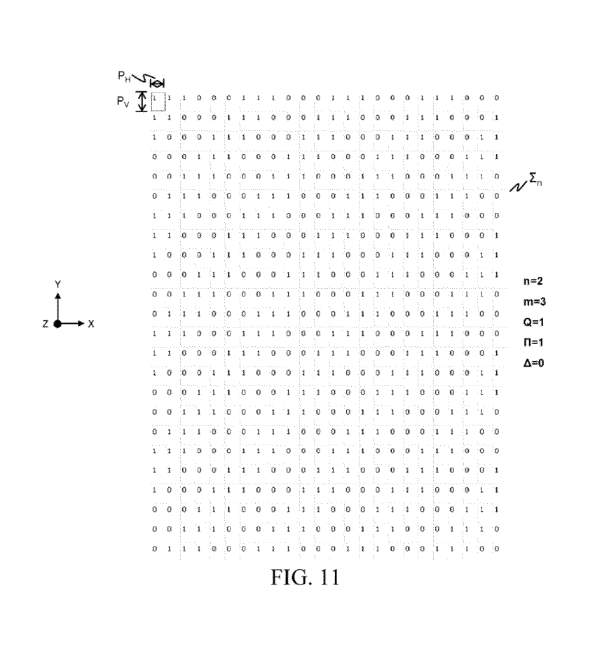

FIG. 2 to FIG. 9 show multi-view combined 3D images Σₙ having the right slantwise feature generated according to the formula (3) with various parameters. 0, 1, 2, 3 in the drawings are the view numbers. A multi-view combined 3D image Σₙ without the slantwise feature may also be generated by substituting special parameters in the formula (3), as shown in FIG. 10. In addition, the multi-view combined 3D image Σₙ having the left slantwise feature is generated according to the formula (4), as shown in FIG. 11. To simplify the drawings and illustrate the efficacy of the present invention, first, a 2-view combined 3D image (as shown in FIG. 4) having the right slantwise feature formed of n=2, m=3, Q=1, Δ=0, and Π=1 is mainly taken as an example to illustrate the structure, the view separation effect, the spatial distribution of the optimum viewing points, and the allowable horizontal and vertical viewing ranges and freedom of the slantwise strip parallax barrier.

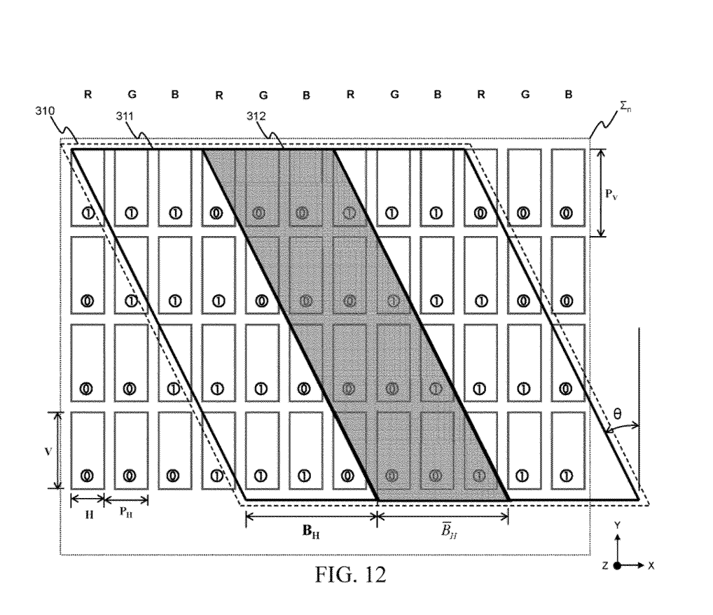

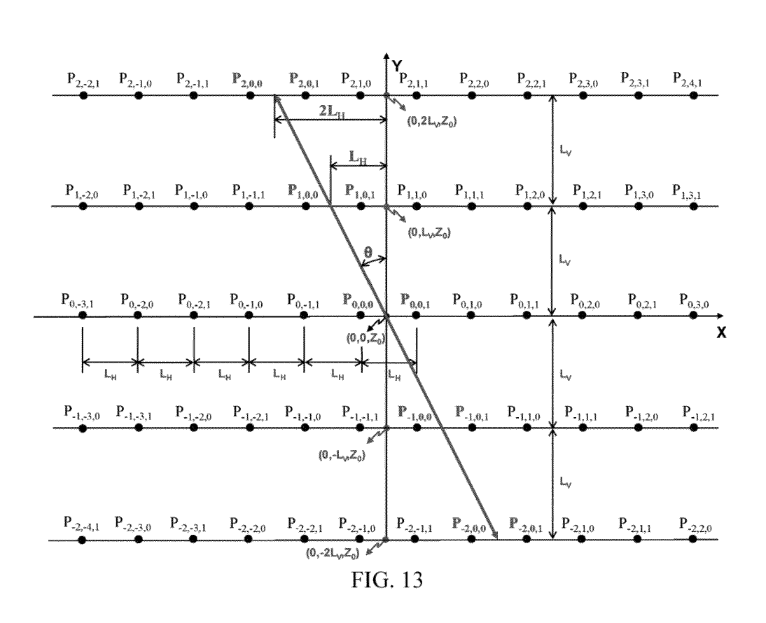

FIG. 12 is the schematic view of a structure of a 2-view slantwise strip parallax barrier. The 2-view slantwise strip parallax barrier 310 is mainly formed of multiple slantwise strip transparent components 311 and multiple slantwise strip opaque components 312, and features repetitively interlacing configuration in the horizontal direction. The transparent components 311 and the opaque components 312 respectively have a horizontal width B_{H} and B̅_{H} and a slant angle θ. In a screen coordinate system, for the 2-view combined 3D image Σₙ (as shown in FIG. 4), the 2-view slantwise strip parallax barrier 310 may perform the optical effect of view separation on the combined 3D image Σₙ and provide multiple optimum viewing points with fixed positions at an optimum viewing distance Z₀, and perform the optical effect of view separation on the optimum viewing point to achieve the objective of respectively presenting a single view image. The positions of multiple optimum viewing points are defined by P_{k,i,j}(x_{c},y_{c},Z₀), as shown in FIG. 13. x_{c} and y_{c} are represented as follows:

x_{c}[n×i−(n−1)/2+j−k]×L_{H} (5-1); and

y_{c}=k×L_{V} (5-2),

where n is the total view number, i is the horizontal viewing zone number, j is the view number, k is the vertical viewing zone number, L_{H} is the horizontal interval between two optimum viewing points, and L_{V} is the vertical interval between two optimum viewing points. The parameters such as i, j, k, L_{H}, and L_{V} are as illustrated below. In addition, the plane where all P_{k,i,j}(x_{c},y_{c},Z₀) exist is the plane Z=Z₀ and is referred to as an “optimum viewing plane”.

First, the principle of generating an optimum viewing point P_{0,i,j}(x_{c},y_{c},Z₀) on a horizontal line y_{c}=0 (that is, k=0) is illustrated.

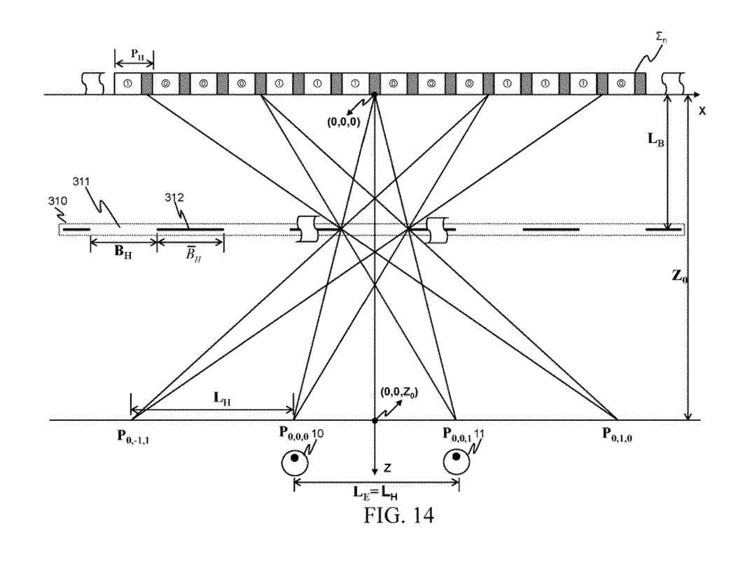

FIG. 14 is a schematic view of the principle of displaying a 2-view combined 3D image. For a 2-view combined 3D image (that is, the image formed of \textcircled{0} and \textcircled{1}, in which \textcircled{0} is the left image and \textcircled{1} is the right image) displayed on the flat-panel display screen 1, the 2-view slantwise strip parallax barrier 310 may respectively separate the 2-view combined 3D image into single view images \textcircled{1}, \textcircled{0}, \textcircled{1}, and \textcircled{0} at the optimum viewing distance Z₀ and at multiple optimum viewing points P_{0,-1,1}, P_{0,0,0}, P_{0,0,1}, and P_{0,1,0} in the horizontal direction (the horizontal distance between two optimum viewing points, that is, the horizontal interval between two optimum viewing points L_{H}). To achieve the efficacy of view separation at Z₀, the B_{H}, B̅_{H}, L_{H}, and θ that form the 2-view slantwise strip parallax barrier 310 need to be designed by the following formulas:

$$\begin{matrix}{B}_{H} = \frac{{mP}_{H} {L}_{H}}{{mP}_{H} + {L}_{H}} ; & ( 6 ) \\ {\overline{B}}_{H} = ( n - 1 ) {B}_{H} ; & ( 7 ) \\ {L}_{H} = \frac{{mP}_{H} {B}_{H}}{{mP}_{H} - {B}_{H}} ; and & ( 8 ) \\ tan θ = \frac{{P}_{H}}{{QP}_{V}} . & ( 9 )\end{matrix}$$

The slantwise strip parallax barrier 310 formed by the formulas (6) to (9) needs to be disposed at the Z=L_{B}. The relation between Z₀ and L_{B} is shown in the following formula:

$${Z}_{0} = \frac{{mP}_{H}}{{mP}_{H} - {B}_{H}} {L}_{B} . \qquad ( 10 )$$

In addition, the formulas (6) and (8) may also be represented as follows:

$$\begin{matrix}{B}_{H} = \frac{{Z}_{0} - {L}_{B}}{{Z}_{0}} {mP}_{H} ; and & ( 11 ) \\ {L}_{H} = \frac{{Z}_{0}}{{L}_{B}} {B}_{H} . & ( 12 )\end{matrix}$$

The formulas (6) to (12) are also applicable to the designs of a vertical strip parallax barrier, a slant-and-step parallax barrier, a vertical lenticular lens array, a slant lenticular lens array, and a slant-and-step micro lenticular lens array (referring to ROC Patent Applications No. 098128986, No. 099107311, No. 099108528, No. 099127429, No. 099128602, and No. 099134699). For the various view separation devices such as the parallax barriers and the lenticular lens arrays, the view separation device has the feature of an unchangeable optical structure (for example, the width and the disposed position of the transparent component of the parallax barrier) and is thus referred to as a “static view separation device” in general. Definitely, the design of the optical structure of the parallax barrier in the horizontal direction, as shown in the formulas (6) to (12), and the design of the optical structure of the parallax barrier in the vertical direction (as illustrated below) are also applicable to the design of the dynamic liquid crystal parallax barrier disclosed in ROC Patent Application No. 098145946.

In addition, for the illustration of the principle in FIG. 14, let n=2, m=3, and Q=1 in the formulas (6) to (9). Generally, in the design of the parallax barrier, the horizontal interval between two optimum viewing points L_{H} is equal to an interpupillary distance (IPD) L_{E}, that is:

L_{H}=L_{E} (13).

In the following, L_{E} may also be used to represent the horizontal interval between two optimum viewing points L_{H}. Therefore, as long as the left and right eyes 10 and 11 of the viewer are respectively at suitable positions, for example, (P_{0,0,0} and P_{0,0,1}), the viewer may view the 3D image without the ghost image. The two optimum viewing points P_{0,0,0} and P_{0,0,1} form a group of viewing zones. Therefore, according to the basic principle in FIG. 14, the definitions of i and j in the optimum viewing point P_{k,i,j}(x_{c},y_{c},Z₀) is further illustrated.

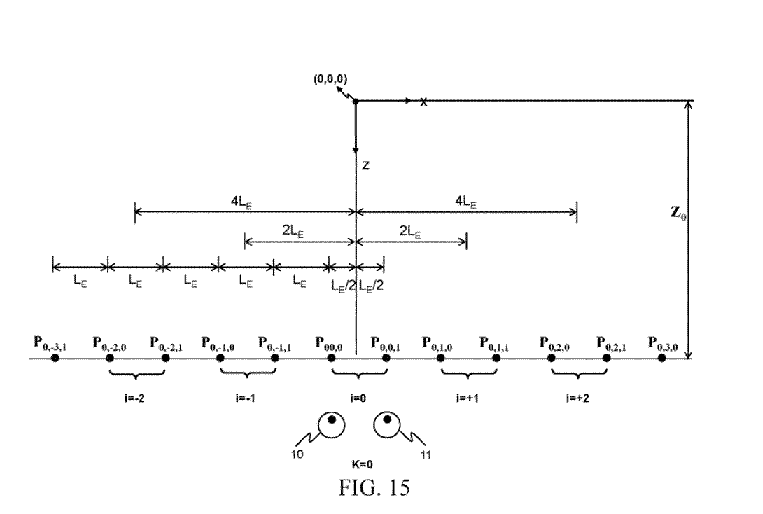

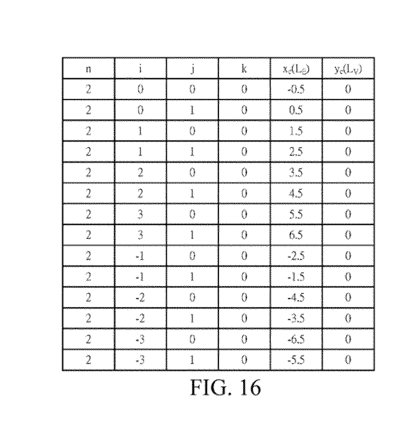

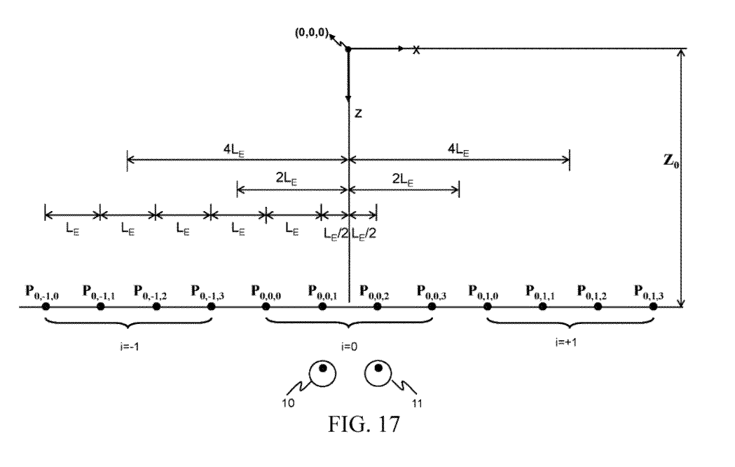

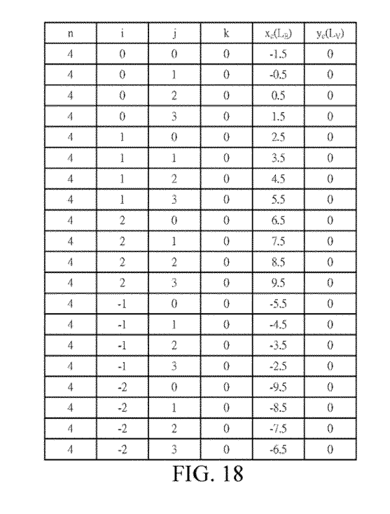

As shown in FIG. 15, i is a viewing zone number and is an integer; while j is a view number and is zero or a positive integer, and j<n. When i=0, the viewing zone is at a position facing the center of the screen. When i>0, the viewing zone is distributed at a position on the right side of the screen. When i<0, the viewing zone is distributed at a position on the left side of the screen. In the case that n=2, when j=0, it is the left image, and when j=1, it is the right image. Therefore, according to the formula (5-1) and k=0, the coordinates x_{c} of each horizontal optimum viewing point in each viewing zone such as i=0, i=±1, i=±2, and i=±3 can be obtained through calculation, as shown in FIG. 16. The distance of x, is represented with L_{E} as a unit. In addition, FIG. 17 and FIG. 18 are schematic views of positions and coordinates of each horizontal optimum viewing point in all viewing zones when n=4, i=0, and i=±1, where j=0 represents the leftmost image, and j=3 represents the rightmost image. When the viewing positions of the left and right eyes 10 and 11 are respectively aligned with adjacent optimum viewing points in the same viewing zone, the correct 3D image can be viewed. If the aligned optimum viewing points are optimum viewing points in different viewing zones, a pseudo stereoscopic 3D image is viewed.

In the following, the relation between the reduction of the horizontal aperture width of the transparent component and the horizontal viewing freedom is illustrated. According to an optimization method of a horizontal aperture component of a parallax barrier disclosed in ROC Patent Applications No. 098128986 and No. 099107311, that is, by using a suitable method for reducing the aperture width, the objectives of eliminating the direct ghost image in the horizontal direction and increasing the degree of horizontal viewing freedom can be achieved.

According to ROC Patent Application No. 099107311, the relation between the allowable horizontal viewing range ΔX_{VF} and the reduction of the horizontal aperture width of the transparent component ΔB_{H} is defined by the following formula:

$$Δ {X}_{VF} = \frac{Δ {B}_{H}}{{B}_{H}} {L}_{E} , \qquad ( 14 )$$

where B_{H} and L_{E} as are defined above. In addition, the horizontal viewing freedom Rₓ is defined by the following formula:

Rₓ=ΔB_{H}/B_{H} (15).

As 0≦ΔB_{H}≦B_{H}, 0≦Rₓ≦1. In addition, the formula (14) is substituted in the formula (15) to obtain:

ΔX_{VF}=Rₓ×L_{E} (16).

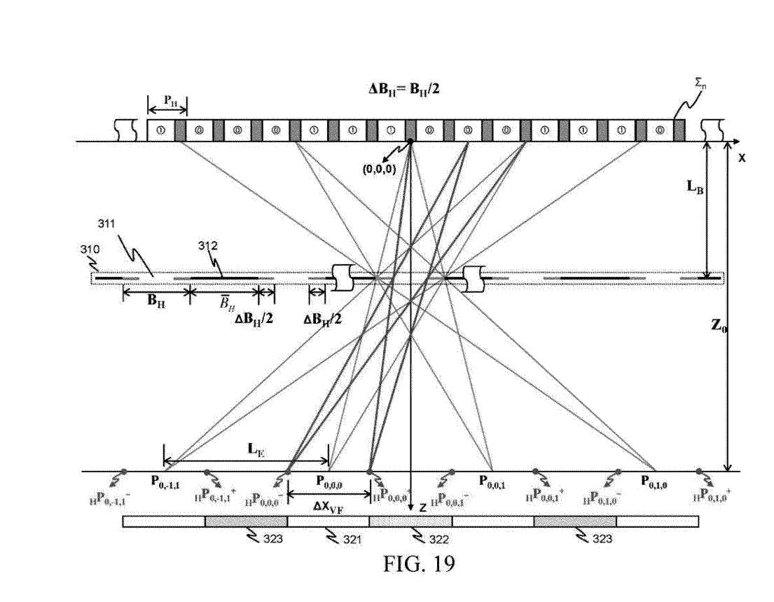

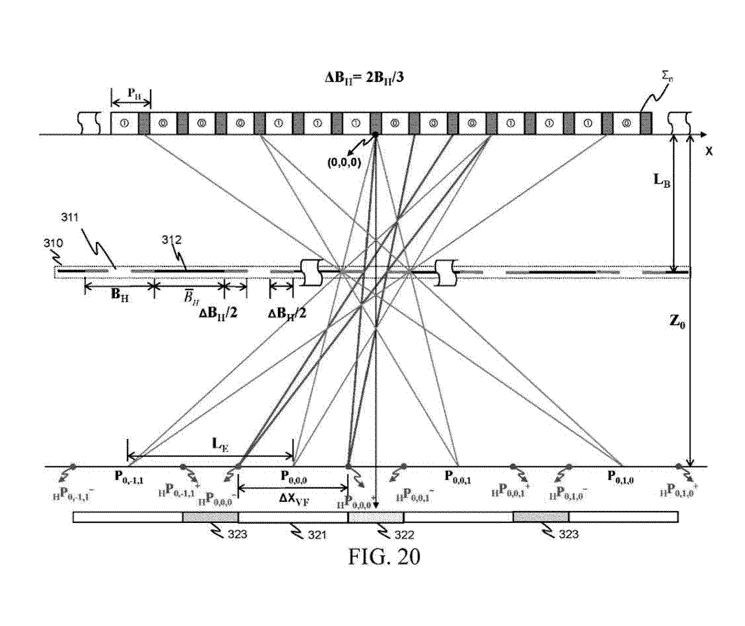

FIG. 19 is a schematic view of an allowable horizontal viewing range ΔX_{VF} when the reduction of the horizontal aperture width of the transparent component is ΔB_{H}=B_{H}/2. When ΔB_{H}=B_{H}/2, Rₓ=0.5 and ΔX_{VF}=0.5L_{E} are obtained. As shown in FIG. 20, when ΔB_{H}=2B_{H}/3, ΔRₓ=2/3 and X_{VF}=2L_{E}/3 are obtained. The so-called “allowable horizontal viewing range” refers to the allowable largest horizontal movement range at the optimum viewing point without perceiving the ghost image when the viewing position is changed in the horizontal direction. The “horizontal viewing freedom” is a numerical value between 0 and 1 defined with respect to the IPD L_{E} to evaluate the degree of convenience of horizontal viewing. That is, when the value of Rₓ is larger, a larger allowable horizontal viewing range is obtained, and the viewing becomes more convenient. In addition, to describe the position of the allowable horizontal viewing range more precisely, for any arbitrary horizontal optimum viewing point P_{k,i,j}, two more positions such as _{H}P_{k,i,j}⁺(x_{c}Δx_{H},y_{c},Z₀) and _{H}P_{k,i,j}⁻(x_{c}−Δx_{H},y_{c},Z₀) are further defined to describe positions of two endpoints of the allowable horizontal viewing range. Δx_{H} is half of the allowable horizontal viewing range and is represented by the following formula:

Δx_{H}=ΔX_{VF}/2=Rₓ×L_{E}/2 (17).

Therefore, as shown in FIG. 19 and FIG. 20, the allowable horizontal viewing range 321 (that is, the horizontal ghost-free image zone) is defined by the following formula:

_{H}P_{k,i,j}⁻≦x≦_{H}P_{k,i,j}⁺ (18).

The horizontal ghost image zone 322 that exists in the same viewing zone is defined by the following formula:

_{H}P_{k,i,j}⁺<x<_{H}P_{k,i,j+1}⁻ (19),

where 0≦j≦n−2. The horizontal ghost image zone 323 that exists in the adjacent viewing zones is defined by the following formula:

_{H}P_{k,i-1,n-1}⁺<x<_{H}P_{k,i,0}⁻ (20).

In conclusion, the slantwise strip parallax barrier (including all the static view separation devices) has a fixed structure and the static multi-view 3D image combination method is applied to generate and display the multi-view combined 3D image at a fixed position on the screen. Therefore, when the positions of the eyes of the viewer depart from the optimum viewing points and exceed the allowable horizontal viewing range 321, the viewer views a ghost image or even views a pseudo stereoscopic image with left and right images inverted, thereby causing problems such as the viewing inconvenience (the horizontal movement of the head is not allowed in a larger range) or the low 3D image quality and eventually causing the phenomenon that the viewer gets dizzy (when the ghost image is severe or the pseudo stereoscopic image is viewed, the brain cannot combine the left and right images into a 3D image).

In the following, the optical effect in the vertical direction is illustrated. In the formulas (5-1) and (5-2), when y_{c}≠0 (that is, k≠0), as shown in FIG. 13, the distributed position of the optimum viewing point P_{k≠0,i,j}(x_{c},y_{c},Z₀) is the same as the distributed position of P_{k=0,i,j}(x_{c},y_{c},Z₀) when y_{c}=0 (that is, k=0). In fact, the distributed positions of the optimum viewing points P_{k≠0,i,j}(x_{c},y_{c},Z₀) in the vertical direction are obtained by displacing all the P_{k=0,i,j}(x_{c},y_{c},Z₀) in a slant line along the slant angle θ. When the horizontal component of the displacement is equal to one L_{H}(=L_{E}), the vertical component of the displacement is L_{V}. Therefore, for the viewer at the start viewing position, for example, the left eye of the viewer being at P_{k=0,i=0,j=0}(x_{c}=−0.5L_{E},y_{c}=0,Z₀), when the viewer changes the viewing position in the vertical direction and the displacement reaches one +L_{V}, the position of the left eye of the viewer changes into P_{k=1,i=0,j=1}(x_{c}=−0.5L_{E},y_{c}=L_{V},Z₀). That is, when the viewing position is changed in the vertical direction, because the view separation is also effected in the vertical direction, a different single view is perceived once at every distance of the vertical interval between two optimum viewing points L_{V}. Therefore, the distribution of the optimum viewing points P_{k,i,j} of the view separation device having the slantwise structure also has the same slantwise feature.

The relations among the optical effect of view separation in the vertical direction, the reduction of the vertical aperture width of the transparent component, and the vertical viewing freedom are illustrated.

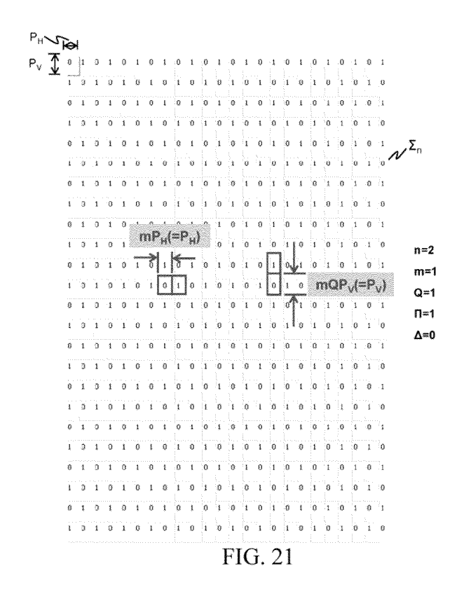

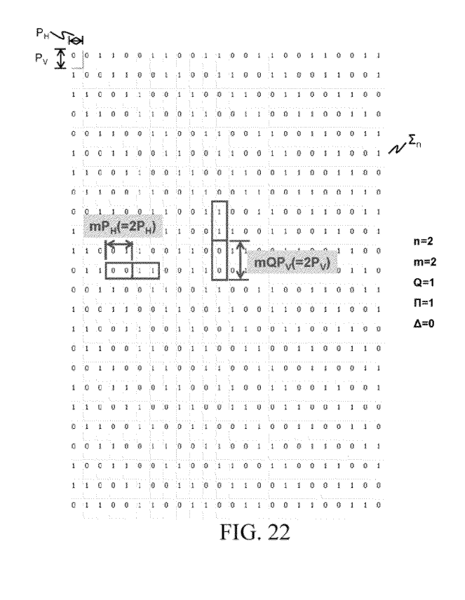

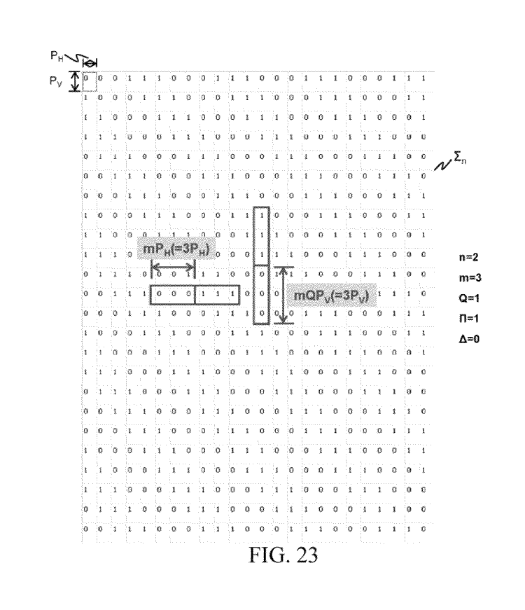

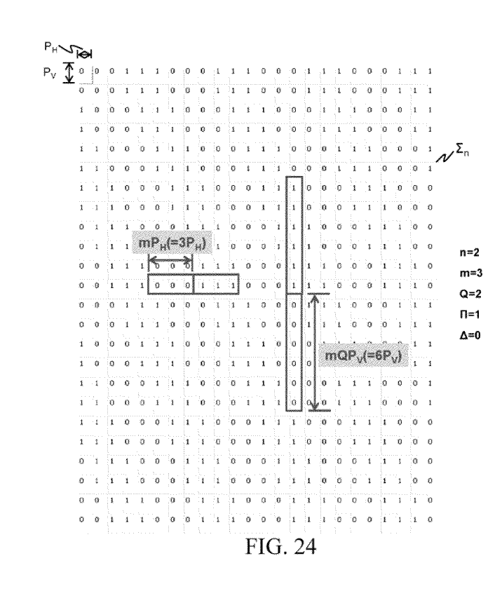

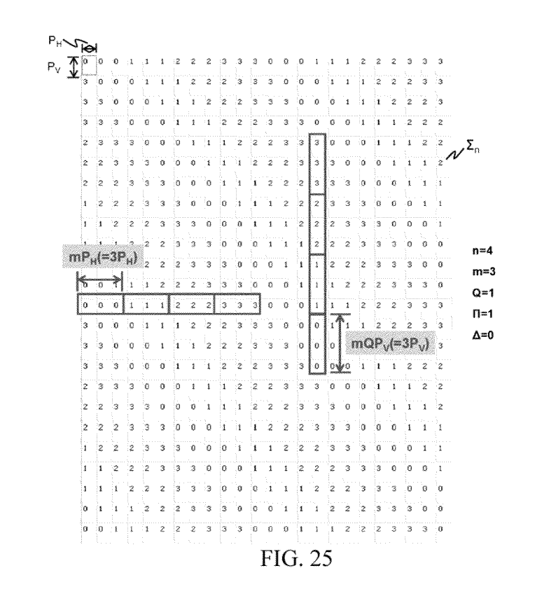

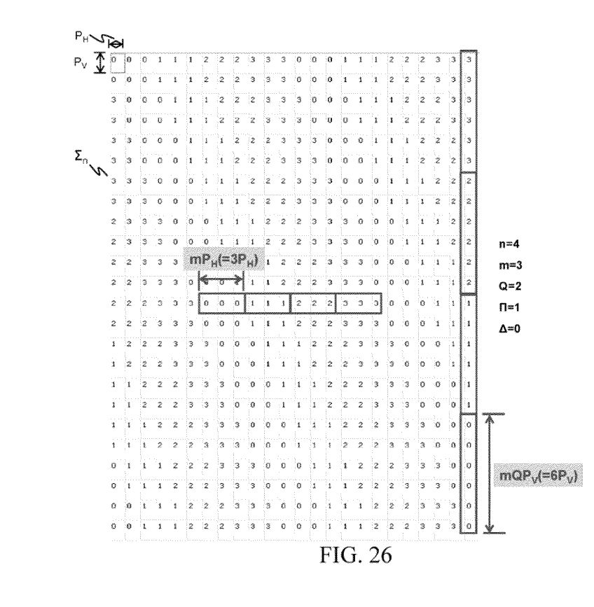

As the view separation device has the optical effect of view separation in the horizontal and vertical directions, for the multi-view combined 3D image Σₙ generated through the formulas (3) and (4), the view separation device is applied to perform view separation on a single view image having periodic distribution in both the horizontal and vertical directions in the combined 3D image. FIG. 21 to FIG. 26 show a multi-view combined 3D image Σₙ formed of various parameters. In the image Σₙ, each single view image has the feature of horizontal and vertical periodic distribution. The number (0, 1, 2, or 3) displayed on a sub-pixel represents the index of the single view image. Therefore, in the multi-view combined 3D image Σₙ, the single view image uses m×n sub-pixels as a unit in the horizontal direction to make periodic configuration; and uses m×Q×n sub-pixels as a unit in the vertical direction to make periodic configuration. Definitely, the optical effect of the vertical direction also follows the optical behaviors specified by the optical formulas in the horizontal direction. Therefore, both the vertical aperture width of the transparent component B_{V} and the vertical interval between two optimum viewing points L_{V} are obtained through calculation with the following formulas:

$$\begin{matrix}{B}_{V} = \frac{{Z}_{0} - {L}_{B}}{{Z}_{0}} {mQP}_{V} ; and & ( 21 ) \\ {L}_{V} = \frac{{mQP}_{V} {B}_{V}}{{mQP}_{V} - {B}_{V}} . & ( 22 )\end{matrix}$$

The formula (21) is divided by the formula (11) to obtain the relation between B_{V} and B_{H} as follows:

$$\frac{{B}_{V}}{{B}_{H}} = Q \frac{{P}_{V}}{{P}_{H}} . \qquad ( 23 )$$

The formula (22) is divided by the formula (8) to obtain the relation between L_{V} and L_{E} as follows:

$$\frac{{L}_{V}}{{L}_{E}} = Q \frac{{P}_{V}}{{P}_{H}} . \qquad ( 24 )$$

The formula (9) is substituted in the formula (24) to obtain:

$${L}_{V} = \frac{{L}_{E}}{tan θ} . \qquad ( 25 )$$

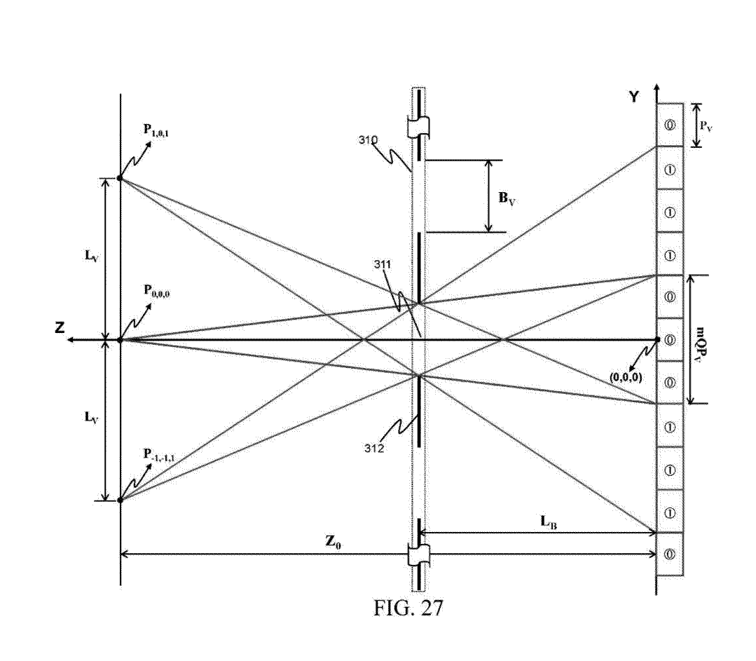

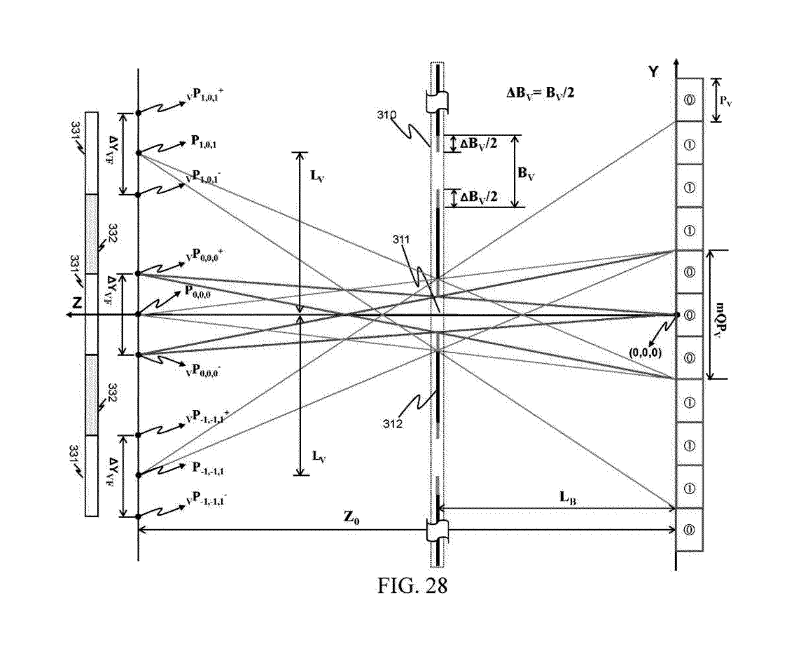

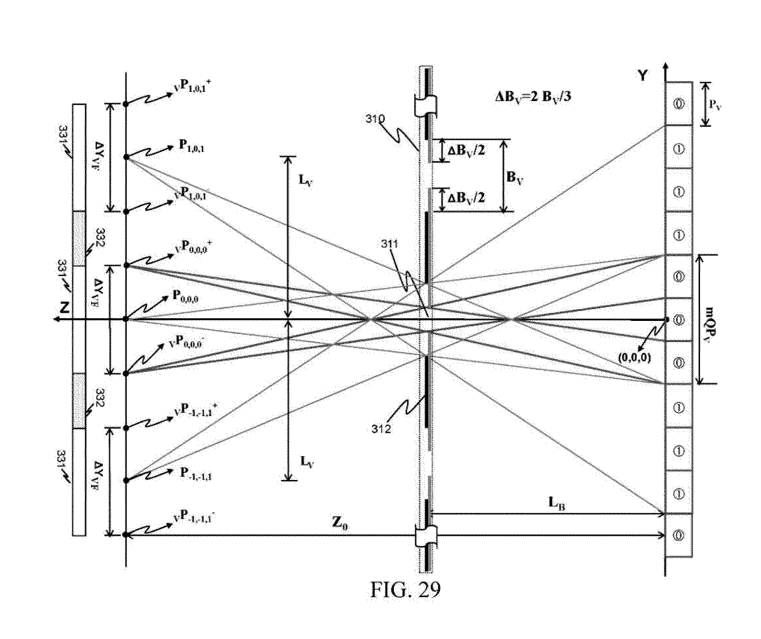

FIG. 27 is a schematic view of an optical effect in the vertical direction of a 2-view slantwise strip parallax barrier. For the analysis of the allowable vertical viewing range and freedom, FIG. 28 is a schematic view of an allowable vertical viewing range ΔY_{VF} when the reducing amount of the vertical aperture width of the transparent component is ΔB_{V}=B_{V}/2. FIG. 29 is a schematic view of an allowable vertical viewing range ΔY_{VF} when the reducing amount of the vertical aperture width of the transparent component is ΔB_{V}=2B_{V}/3. As described above, the relation between the allowable vertical viewing range ΔY_{VF} and the reducing amount of the vertical aperture width of the transparent component ΔB_{V} is defined by the following formula:

$$Δ {Y}_{VF} = \frac{Δ {B}_{V}}{{B}_{V}} {L}_{V} , \qquad ( 26 )$$

where B_{V} and L_{V} are as defined above. In addition, the vertical viewing freedom R_{Y} is defined by the following formula:

R_{Y}=ΔB_{V}/B_{V}(27).

As 0≦ΔB_{V}≦B_{V}, 0≦R_{Y}≦1. In addition, the formula (27) is substituted in the formula (26) to obtain:

ΔY_{VF}=R_{Y}×L_{V} (28).

In addition, the formula (16) is divided by the formula (28) to obtain:

$$\frac{Δ {X}_{VF}}{Δ {Y}_{VF}} = \frac{{R}_{x}}{{R}_{y}} \times \frac{{L}_{E}}{{L}_{V}} . \qquad ( 29 )$$

Let Rₓ=R_{Y}, and the formula (25) is substituted in the formula (29) to obtain:

$$\frac{Δ {X}_{VF}}{Δ {Y}_{VF}} = tan θ . \qquad ( 30 )$$

Similarly, to describe the position of the allowable vertical viewing range more precisely, for any arbitrary horizontal optimum viewing point P_{k,i,j}, two positions _{V}P_{k,i,j}⁺(x_{c},y_{c}+Δy_{V},Z₀) and _{V}P_{k,i,j}⁻(x_{c},y_{c}−Δy_{V},Z₀) are further defined to describe the positions of two endpoints of the allowable vertical viewing range. Δy_{V} is half of the allowable vertical viewing range and is represented by the following formula:

Δy_{V}=ΔY_{VF}/2=R_{Y}×L_{V}/2 (31).

Therefore, as shown in FIG. 28 and FIG. 29, the allowable vertical viewing range 331 (that is, the vertical ghost-free image zone) is defined by the following formula:

_{V}P_{k,i,j}⁻≦y≦_{V}P_{k,i,j}⁺ (32).

The vertical ghost image zone 332 is defined by the following formula:

_{V}P_{k,i,j}⁺<y<_{V}P_{k+1,i′,j′}⁻ (33),

where when j<n−1, i′=i and j′=j+1; and when j=n−1, i′=i+1 and j′=0.

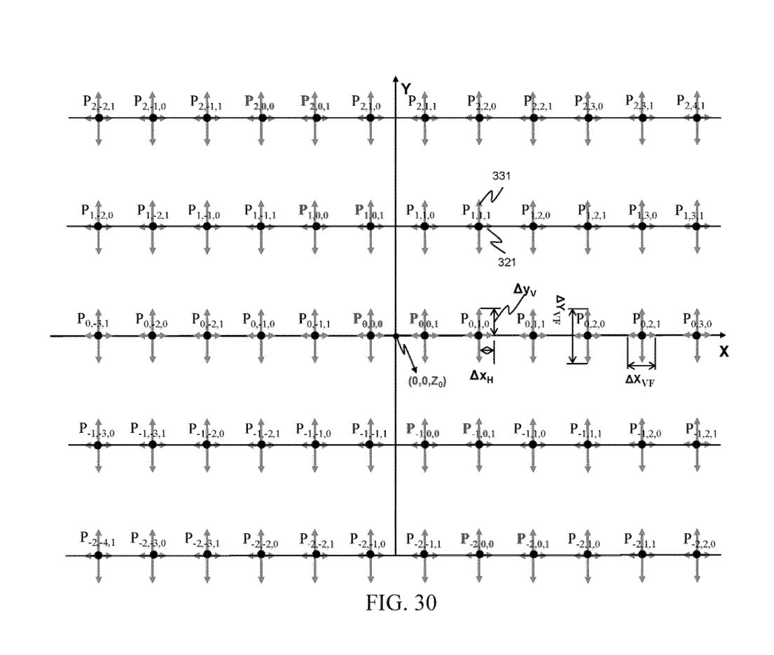

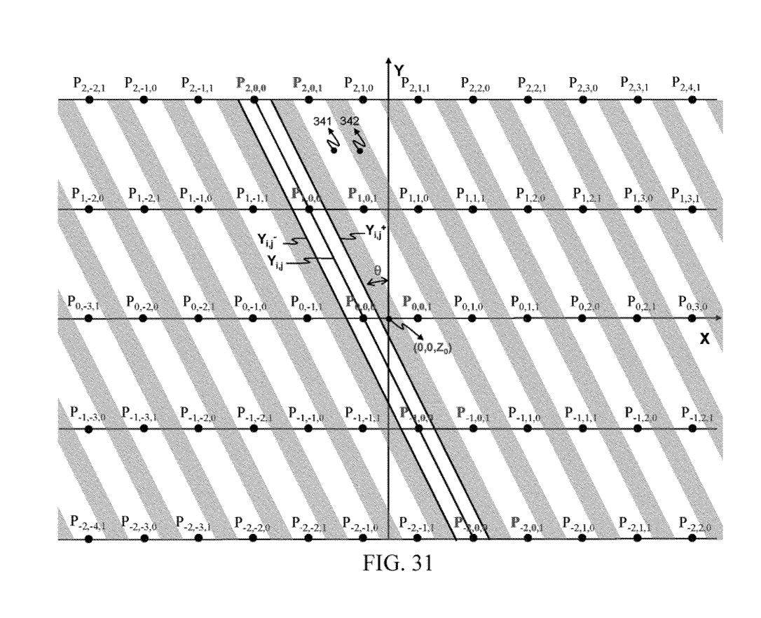

As described above, according to definitions in the formulas (5-1) to (5-2), (18) to (20) and (32) to (33), for any arbitrary optimum viewing point P_{k,i,j}(x_{c},y_{c},Z₀), as shown in FIG. 30, a horizontal allowable viewing range and a vertical allowable viewing range exist. As the view separation device has the feature of optical slanting, the above allowable viewing range and the ghost image zone are distributed along the slant angle θ, as shown in FIG. 31, which eventually form a slantwise strip allowable viewing range 341 and a slantwise strip ghost image zone 342. The slantwise strip allowable viewing range 341 and the slantwise strip ghost image zone 342, the same as the feature of the optical structure of the parallax barrier 310, also feature repetitively interlacing configuration in the horizontal direction. For the slantwise strip allowable viewing range 341, a central line Y_{i,j}(x,y) is defined by the following formula:

y=f(θ){x−[n×i−(n−1)/2+j]×L_{E}} (34)

The central line Y_{i,j}(x,y) passes through all the optimum viewing points P_{k,i,j}(x_{c},y_{c},Z₀) having the same i and j. In addition, the boundary between the slantwise strip allowable viewing range 341 and the slantwise strip ghost image zone 342 is formed by boundary lines Y_{i,j}⁺(x,y) and Y_{i,j}⁻(x,y), where Y_{i,j}⁺(x,y) is represented by the following formula:

y=f(θ){x−[n×i−(n−1)/2+j+Rₓ/2]×L_{E}} (35).

Y_{i,j}⁻(x,y) is represented by the following formula:

y=f(θ){x−[n×i−(n−1)/2+j−Rₓ/2]×L_{E}} (36).

For the view separation device having the right slantwise structure, f(θ) is represented by the following formula:

f(θ)=−tan θ(37).

For the view separation device having the left slantwise structure, f(θ) is represented by the following formula:

f(θ)=tan θ(38).

In addition, when θ=0 (that is, tan θ=0), the view separation device has the feature of the vertical structure (referred to as “the view separation device having the vertical structure” hereinafter), and the Y_{i,j}(x,y), Y_{i,j}⁺(x,y), Y_{i,j}⁻(x,y) become vertical lines, which are respectively represented by the following formulas:

x=[n×i−(n−1)/2+j]×L_{E} (39);

x=[n×i−(n−1)/2+j+Rₓ/2]×L_{E} (40); and

x=[n×i−(n−1)/2+j−Rₓ/2]×L_{E} (41).

In fact, for the central line Y_{i,j}(x,y) and the boundary lines Y_{i,j}⁺(x,y) and Y_{i,j}⁻(x,y) described in the formulas (34) to (36), when y=0, the value of x is obtained, as shown in the formulas (39) to (41). That is, the view separation devices having a slantwise structure and a vertical structure achieve the same optical effect of view separation at the horizontal line of z=Z₀ and y=0. Alternatively, more simply, the slantwise structure and the vertical structure have the same optical effect and only differ in the slant angle. In the following, the horizontal line of z=Z₀ and y=0 is referred to as an optimum viewing line for short. As described above, for the view separation device having an arbitrary slantwise structure, at the optimum viewing distance, the formulas (34) to (41) clearly define the central lines and boundary lines of all the allowable viewing ranges. Therefore, the terms “slantwise strip allowable viewing range” and the “slantwise strip ghost image zone” used above are referred to as the “allowable viewing zone” and the “ghost image zone” for short below. The plane where all of the optimum viewing points, the central lines and the boundary lines of the allowable viewing zone exist (that is, Z=Z₀) is referred to as an optimum viewing plane for short.

As described above, when a static view separation device having an arbitrary slantwise structure and a static multi-view 3D image combination method are used to display a 3D image, in an optimum viewing plane, as shown in FIG. 31, the allowable viewing zone 341 and the ghost image zone 342 are specified by the formulas (34) to (41). For a viewer at the optimum viewing plane, when the positions of the left and right eyes of the viewer depart from the allowable viewing zone 341 (that is, enter the ghost image zone 342), the viewer perceives the ghost image. In addition, when the positions of the left and right eyes of the viewer are within different viewing zones, the viewer perceives a pseudo stereoscopic image. For the above features, the method that applies the static view separation device having an arbitrary slantwise structure and the static multi-view 3D image combination to display a 3D image is referred to as a static displaying method of a 3D image for short below.

2. Dynamic Multi-View 3D Image Combination Method

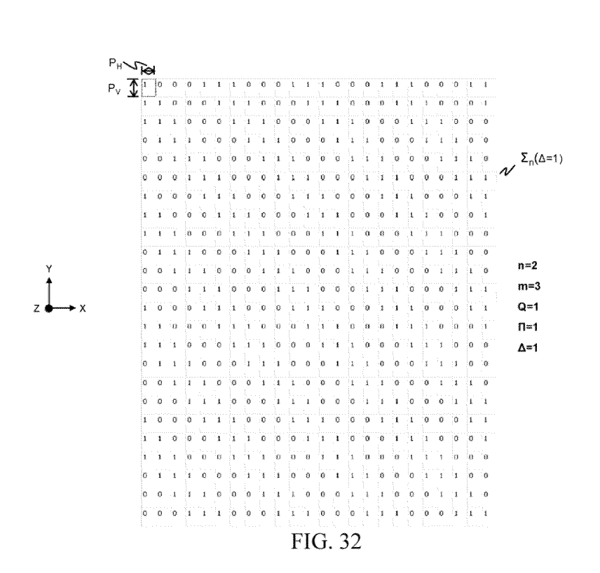

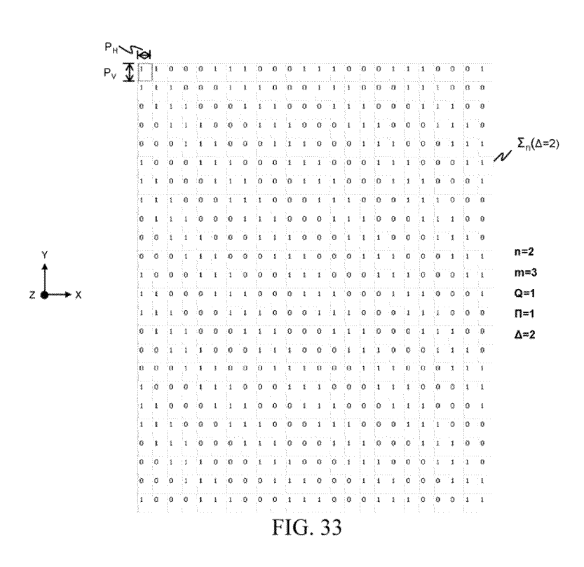

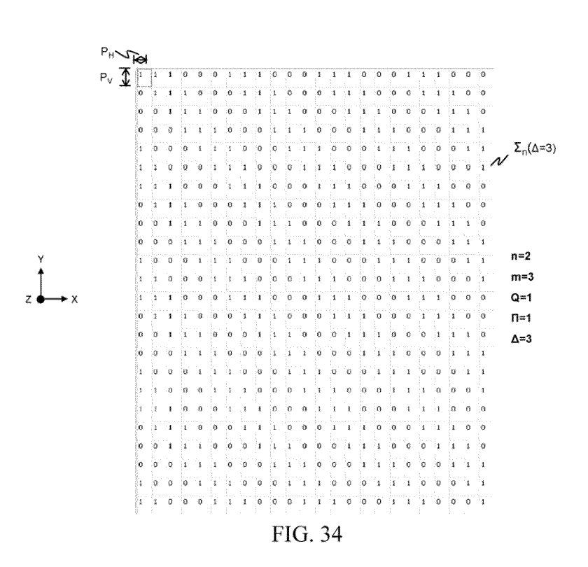

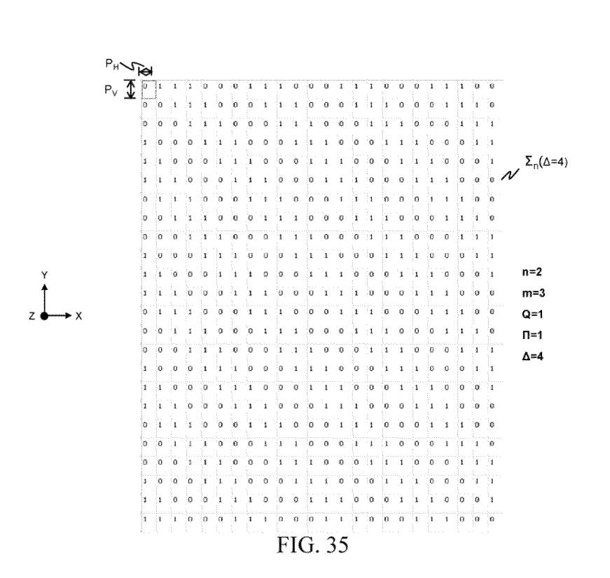

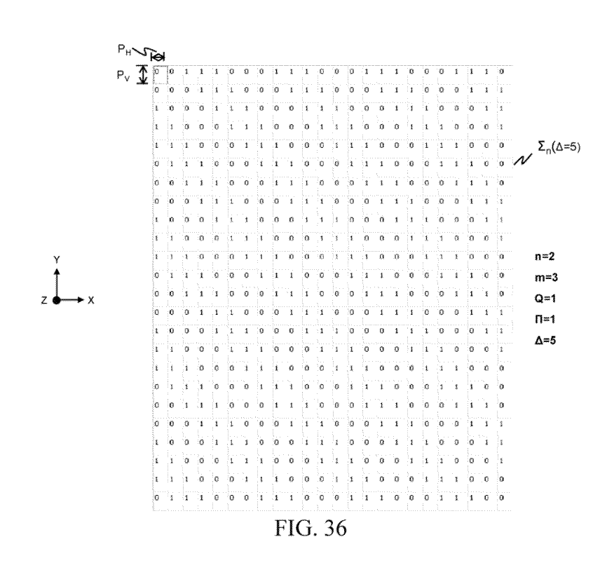

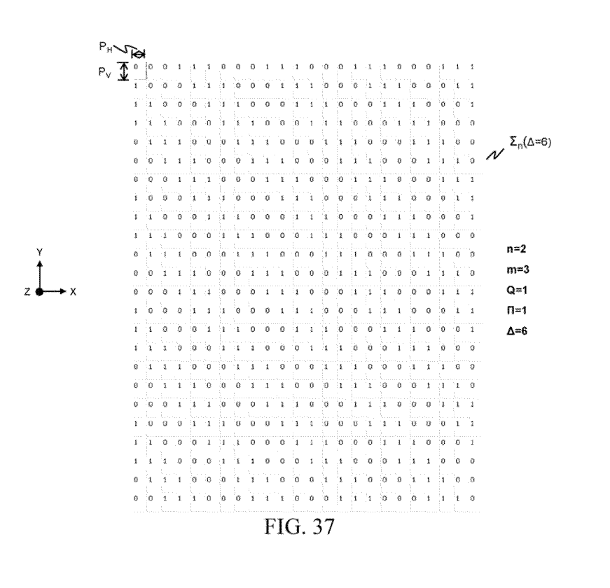

The “dynamic multi-view 3D image combination” is illustrated. For the multi-view 3D image combination method in the formulas (3) and (4), the parameters such as n, m, Q, and H are related to the design of the hardware structure of the static view separation device, and are constants that do not change with time. For the 2-view combined 3D image of n=2, m=3, Q=1, Π=1, and Δ=0 shown in FIG. 4, when Δ changes from 1 to 6, the 2-view combined 3D images Σₙ(Δ=1) to Σₙ(Δ=6) shown in FIG. 32 to FIG. 37 are obtained. When the horizontal displacement phase Δ>0, it represents that all the sub-pixel image data of each view V_{K}^{i,j} uses the sub-pixels as a unit to displace to the right by Δ sub-pixels, and has an n×m period. That is, when Δ=6 and Δ=0, the combined 3D image structure is the same. Definitely, when Δ<0, it represents that the sub-pixel image data Vₖ^{i,j} may achieve the objective of displacing to the left. Due to the periodic relation, Δ=A (displacement to the right by A sub-pixels) and Δ=A−n×m (displacement to the left by n×m−A sub-pixels) have the same combined 3D image structure. Therefore, the illustration is no longer provided.

As described above, the so-called “dynamic multi-view 3D image combination” is to make the horizontal displacement phase A as a variable, for example, a function of time to set the value of Δ(t) in a certain condition that occurs at a certain time point (as illustrated below). Therefore, the formulas (3) and (4) are expressed as follows:

$$\begin{matrix}Λ ( t ) = Mod [ int ( \frac{j - Π \times int ( \frac{i + Δ ( t )}{Q} )}{m} ) , n ] ; and & ( 42 ) \\ Λ ( t ) = Mod [ int ( \frac{( N - 1 ) - j - Π \times int ( \frac{i + Δ ( t )}{Q} )}{m} ) , n ] . & ( 43 )\end{matrix}$$

Compared with the above static displaying method of a 3D image, the method of the present invention is applicable to displaying of a 3D image with the time as a variable, so that the method belongs to a dynamic displaying method of a 3D image. In the following, to simplify the expressions of the mathematical formulas, the relevant parameters related to time are no longer explicitly shown as the function of time, for example, the horizontal displacement phase and the coordinate values of the left and right eyes described below.

3. Optimization Method of Viewing Freedom

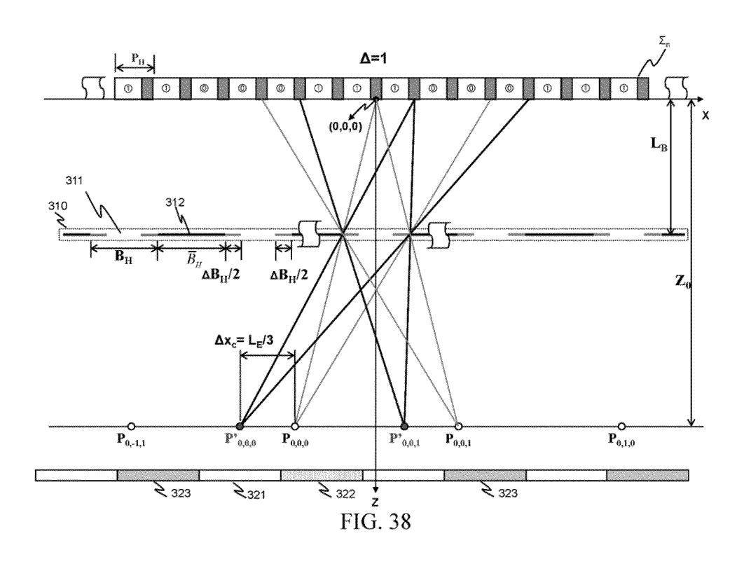

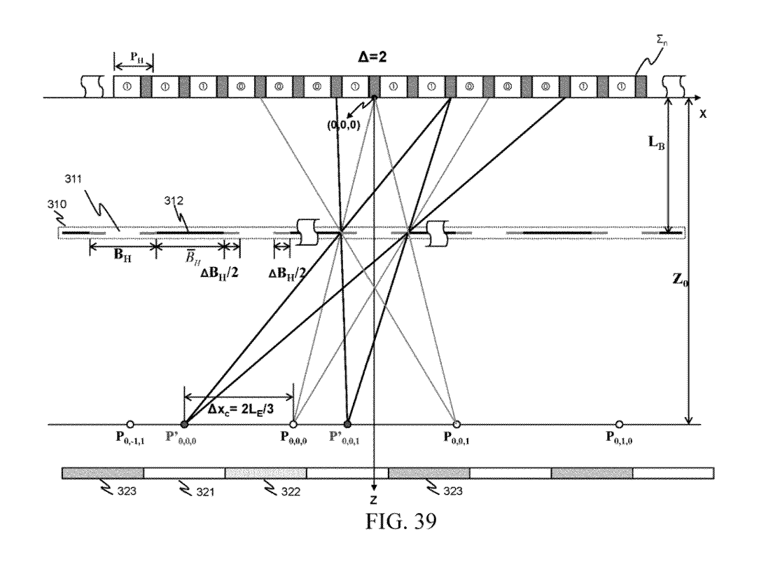

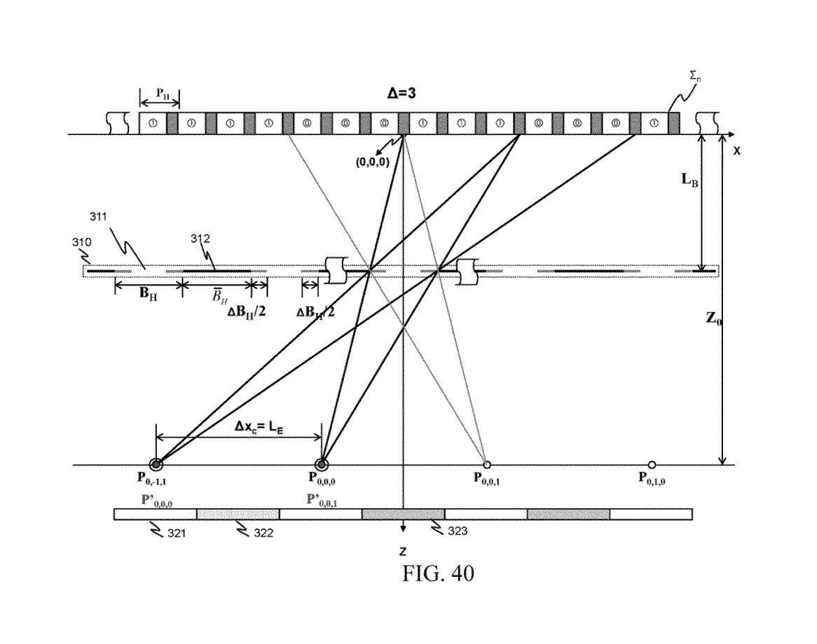

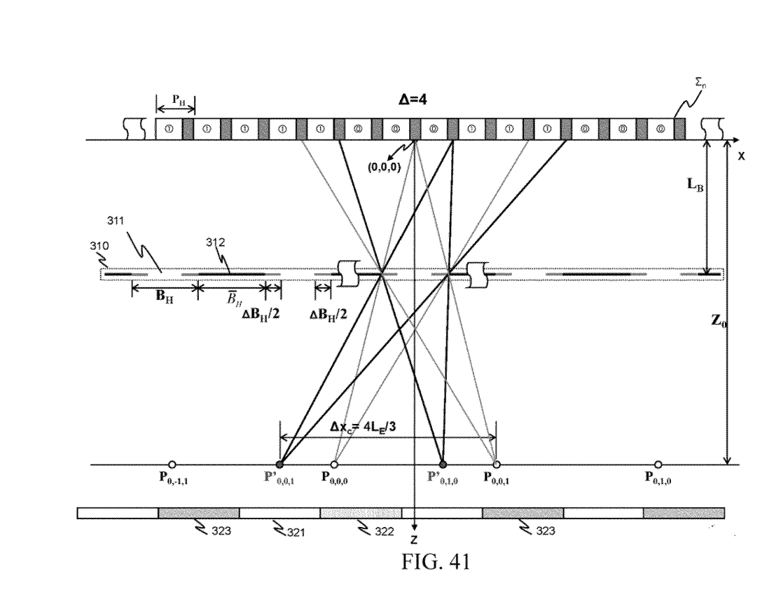

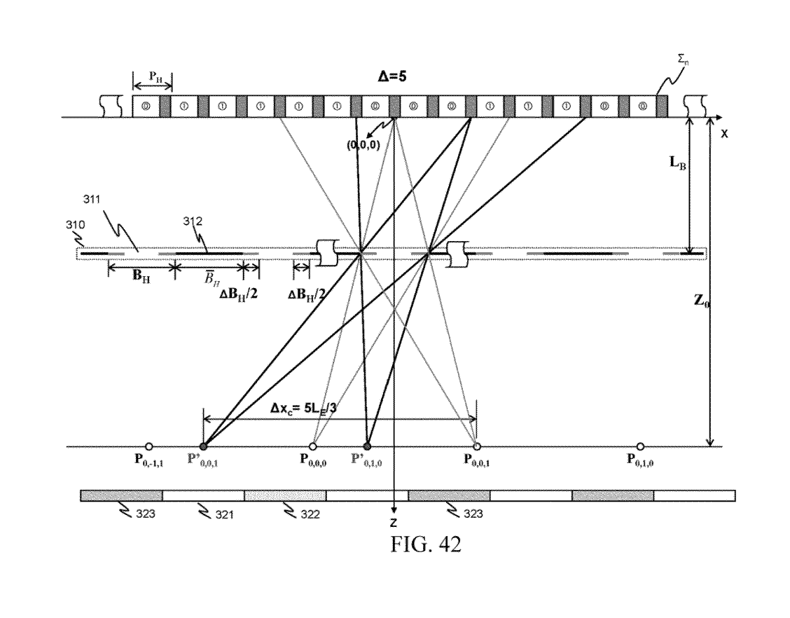

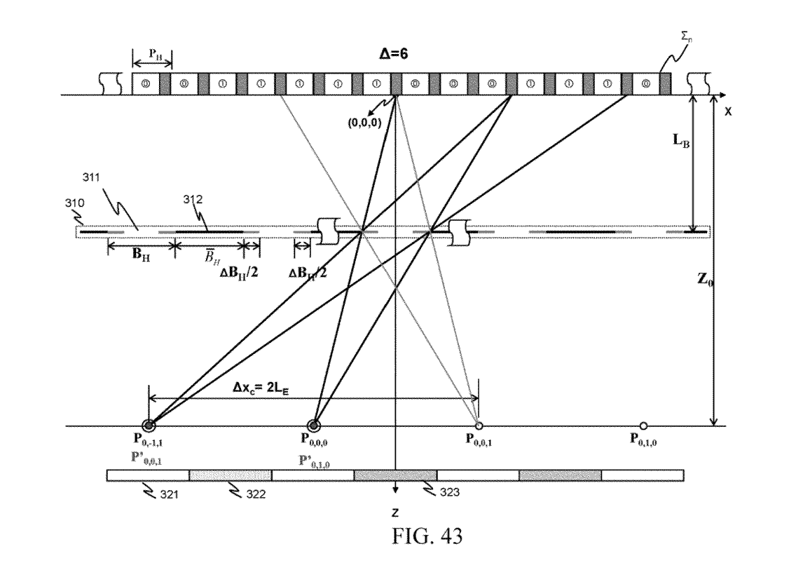

As described above, the combined 3D image structure is changed by changing the value of the horizontal displacement phase Δ. Therefore, the objective of changing the position of the optimum viewing point is achieved. For 2-view combined 3D images Σₙ(Δ=1) to Σₙ(Δ=6), through the effect of the 2-view slantwise strip parallax barrier shown in FIG. 19, compared with the positions of all the optimum viewing points P_{k,i,j}(x_{c},y_{c},Z₀) at Δ=0 originally, when Δ≠0, all P_{k,i,j}(x_{c},y_{c},Z₀) horizontally displace to the left by Δx_{c} to become the optimum viewing points P′_{k,i,j}(x′_{c},y_{c},Z₀) after the movement. In the following, P_{k,i,j}(x_{c},y_{c},Z₀) is referred to as a primary optimum viewing point; and the P′_{k,i,j}(x′_{c},y_{c},Z₀) is referred to as a secondary optimum viewing point. As shown in FIG. 38 to FIG. 43, x′_{c} is represented by the following formula:

x′_{c}=x_{c}−Δx_{c} (44),

where

Δx_{c}=Δ×L_{E}/m (45).

Δx_{c} is a modulating interval between two optimum viewing points. When Δ=1, Δx_{c0} is a smallest modulating interval between two optimum viewing points, as shown by the following formula:

Δx_{c0}=L_{E}/m (46).

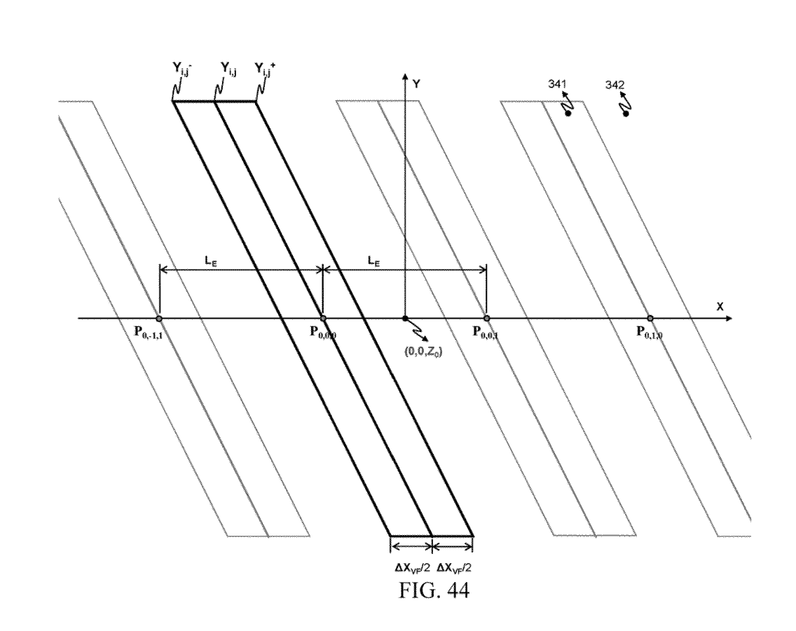

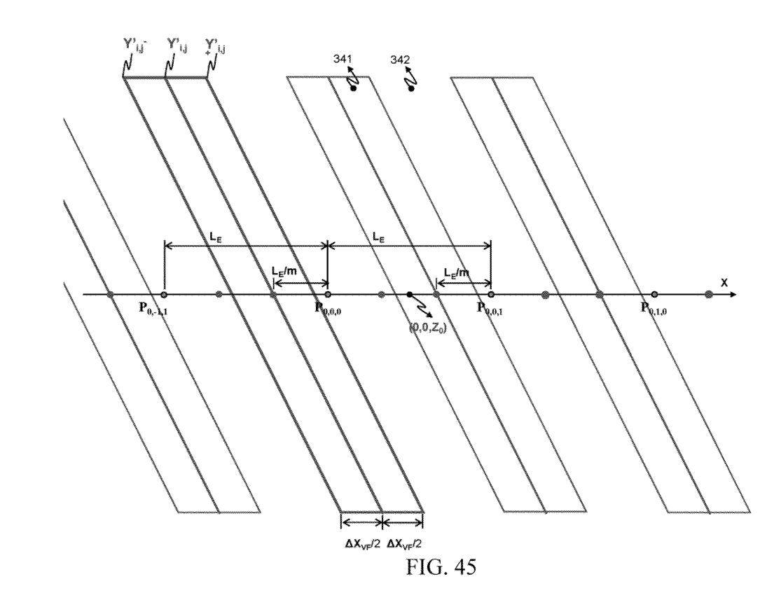

Therefore, when m is larger (in the illustration above, m=3), a smaller Δx_{c0} is obtained. In addition, as the view separation device is a linear optical system, the central line Y_{i,j}(x,y) and the boundary lines Y_{i,j}⁺(x,y) and Y_{i,j}⁻(x,y) in the allowable viewing zone 341, as shown in FIG. 44 (in FIG. 44, Δ=0), may displace to the left by the same amount Δx_{c} through change of the value of Δ, and as shown in FIG. 45 (in FIG. 45, Δ=1), the central line and the boundary lines after the movement respectively become Y′_{i,j}(x,y), Y′_{i,j}⁺(x,y), and Y′_{i,j}⁻(x,y). That is, by changing the value of Δ, all the allowable viewing zones 341 and the ghost image zones 342 may horizontally displace to the left (when Δ>0), or horizontally displace to the right (when Δ<0). In the following, Y_{i,j}(x,y) is the primary central line, and Y′_{i,j}(x,y) is the secondary central line.

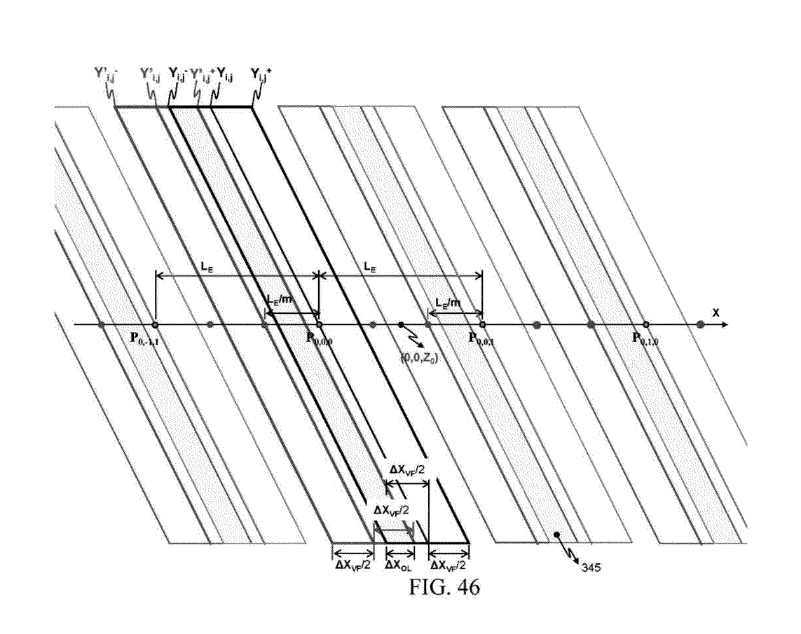

As shown in FIG. 46, the drawings when Δ=0 and Δ=1 are overlapped to observe displacement changes and overlapping situations of the allowable viewing zone before and after the change of Δ. According to the formula (16), the width ΔX_{VF} of the allowable viewing zone 341 (in FIG. 46, Rₓ₌0.5) is obtained through calculation. According to the formula (46), the modulating smallest interval between two primary optimum viewing points Δx_{c0} is obtained through calculation (in FIG. 46, m=3). The allowable viewing zones before and after the change of Δ may overlap when the following condition is satisfied.

ΔX_{VF}>Δx_{c0} (47),

The width ΔX_{OL} of the overlapping zone 345 is represented by the following formula:

ΔX_{OL}=ΔX_{VF}−Δx_{c0} (48).

The formulas (16) and (46) are substituted in the formula (48) to obtain:

ΔX_{OL}=(Rₓ−1/m)×L_{E} (49).

When the formula (49) is greater than zero, the optimization method of viewing freedom is implemented, that is, when Rₓ>1/m, the objective of constructing a ghost-free image zone on an optimum viewing plane is achieved.

For a viewer at an optimum viewing plane, when the viewing position is not suitable or the viewing position is changed, the viewer may perceive the ghost image or the pseudo stereoscopic image. However, as long as the horizontal positions of the left and right eyes of the viewer can be detected in real time, the correct allowable viewing zones can be moved to the positions of the eyes of the viewer through the operation of Δ, so as to completely solve the phenomena of the ghost image and the pseudo stereoscopic image and solve the problem of insufficient viewing freedom.

4. Real-Time Detection Method of Viewing Position

As described above, the viewing positions refer to the 3D positions (the screen coordinate system) of the left and right eyes. A method of recognizing and tracking a spatial point as disclosed in ROC Patent Application No. 096108692, based on a 3D photography technique, uses a pair of left and right camera devices to perform photography and image processing to detect central positions of the left and right eyeballs (or pupils) from the 2D image retrieved from the left and right camera devices (the above is the conventional technology of the digital camera), and then uses a method of left/right image correspondence and a method of 3D coordinate conversion and calculation to obtain the 3D positions of the left and right eyes. In the following, the method of left/right image correspondence and the method of 3D coordinate conversion and calculation are illustrated.

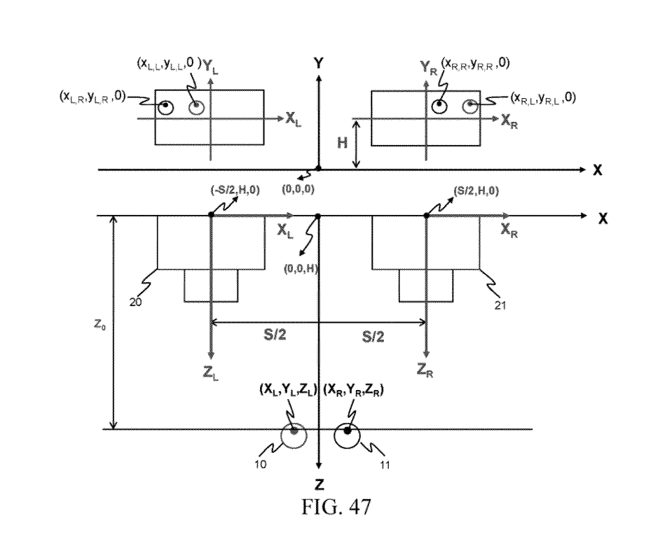

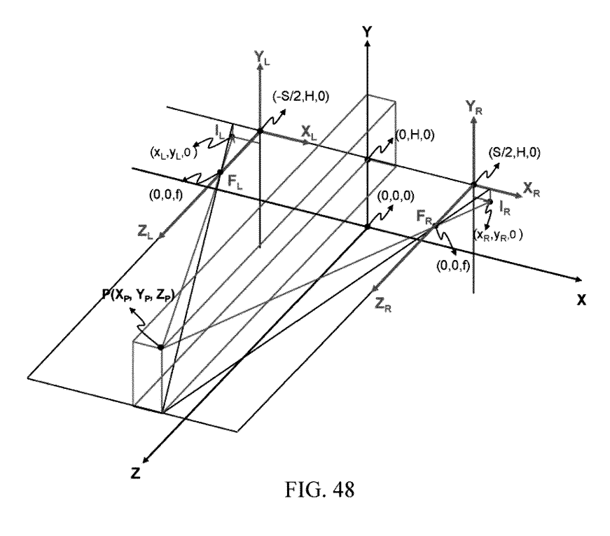

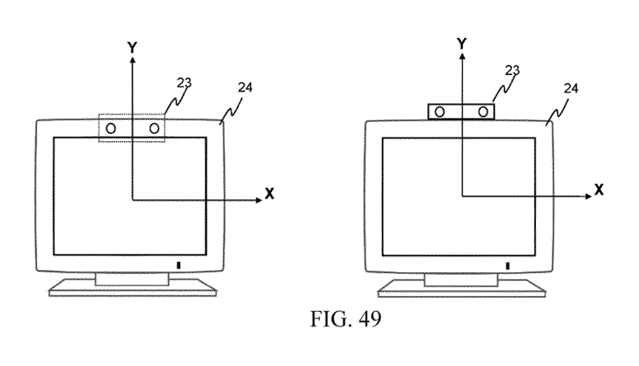

First, the optical feature formed through the 3D photography is illustrated. As shown in FIGS. 47 and 48, the 3D camera device 23 is formed of a left camera device 20 and a right camera device 21. The device, as shown in FIG. 49, is directly embedded within a regular flat-panel display screen frame 24 (on the left), or externally disposed outside the regular flat-panel display screen frame 24 (on the right). Therefore, the left and right cameras 20 and 21 may also be embedded or externally disposed on the casing of a device such as a mobile phone, a digital camera, a video camera, a game console, a tablet computer, a notebook computer, a monitor, a television, and a 3D television.

In addition, the left and right camera devices 20 and 21 are provided with the same optical imaging system, that is, provided with optical imaging lens with the same focal length f (not shown) and the same image sensors (such as a charge-coupled device (CCD) or a complementary metal-oxide-semiconductor (CMOS), not shown). On the left and right camera devices 20 and 21, a left image coordinate system X_{L}Y_{L}Z_{L} and a right image coordinate system X_{R}Y_{R}Z_{R} are respectively set. The origins of the two image coordinate systems are respectively set at the centers of the image sensors of the left and right camera devices 20 and 21, and the coordinate axes of the two image coordinate systems and the screen coordinate system are parallel. In the screen coordinate system, the origin coordinates of the two image coordinate systems are set at (−S/2,H,0) and (S/2,H,0) respectively. S is an interval between optical axes of the left and right camera devices 20 and 21, and H is the height of the device. In addition, Z_{L} and Z_{R} are respectively set on the optical axes of the left and right camera devices 20 and 21. That is, the optical axes of the left and right camera devices 20 and 21 are parallel to the Z-axis.

As shown in FIG. 48, for the optical feature of imaging of the left and right camera devices 20 and 21, for an object point P(Xₚ,Yₚ,Zₚ) in the screen coordinate system, through the operation of optical imaging systems of the left and right video cameras, the image points I_{L}(x_{L},y_{L},0) and I_{R}(x_{R},y_{R},0) are respectively generated on the left and right image sensors, that is, on the left and right image coordinate systems. Let I_{L}(x_{L},y_{L},0) and I_{R}(x_{R},y_{R},0) be the corresponding points of P(X_{P},Y_{P},Z_{P}) and have the following coordinate conversion relation:

$$\begin{matrix}{X}_{P} = - ( \frac{{x}_{L}}{{x}_{R} - {x}_{L}} + \frac{1}{2} ) S ; & ( 50 ) \\ {Y}_{P} = - \frac{{y}_{L}}{{x}_{R} - {x}_{L}} S + H ; and & ( 51 ) \\ {Z}_{P} = [ 1 + \frac{S}{{x}_{R} - {x}_{L}} ] f . & ( 52 )\end{matrix}$$

Therefore, the formulas (50) to (52) can be used for detecting viewing positions. For the left and right eyes 10 and 11 in the screen coordinate system XYZ, the 3D coordinates are defined as follows:

E_{L}=(X_{L},Y_{L},Z_{L}) (53); and

E_{R}=(X_{R},Y_{R},Z_{R}) (54).

The left and right eyes 10 and 11, through the optical lenses of the left and right camera devices 20 and 21, is respectively imaged to the left and right image sensors, and then central positions of the left and right eyeballs (or pupils) is respectively detected through image processing, as described below.

In the left image coordinate system, the central positions of the left and right eyeballs (or pupils) are represented by the following formulas:

i_{L,L}=(x_{L,L},y_{L,L},0) (55); and

i_{L,R}=(x_{L,R},y_{L,R},0) (56).

In the right image coordinate system, the central positions of the left and right eyeballs (or pupils) are represented by the following formulas:

i_{R,L}=(x_{R,L},y_{R,L},0) (57); and

i_{R,R}=(x_{R,R},y_{R,R},0) (58).

Therefore, the above method of left/right image correspondence is to perform corresponding processing on the central positions of the left and right eyeballs on the image sensor of the left and right camera devices 20 and 21. That is, i_{L,L} and i_{R,L} correspond to the left eye position E_{L}, and i_{L,R} and i_{R,R} correspond to the right eye position E_{R}. In addition, as described above, since the left and right camera devices 20 and 21 have the same optical feature, y_{L,L}=y_{R,L}=y_{L} and y_{L,R}=y_{R,R}=y_{R}.

Therefore, the center of the left eyeball (or pupil) corresponds to the positions in the left and right image coordinate systems, which are represented by the following formulas:

i_{L,L}=(x_{L,L},y_{L},0) (59); and

i_{R,L}=(x_{R,L},y_{L},0) (60).

The center of the right eyeball (or pupil) corresponds to the positions in the left and right image coordinate systems, which are represented by the following formulas:

i_{L,R}=(x_{L,R},y_{R},0) (61); and

i_{R,R}=(x_{R,R},y_{R},0) (62).

The so-called “3D coordinate conversion and calculation method” is to convert coordinates of the left and right eyes imaged in the image coordinate system into 3D coordinates in the screen coordinate system through coordinate conversion between the image coordinate system and the screen coordinate system. As described above, according to the formulas (50) to (52), the coordinate conversion is performed on the i_{L,L} and i_{R,L} to obtain the 3D coordinates of the left eye 10 through calculation, that is, the coordinates in the formula (53), which are represented by the following formulas:

$$\begin{matrix}{X}_{L} = - ( \frac{{x}_{L , L}}{{x}_{R , L} - {x}_{L , L}} + \frac{1}{2} ) S ; & ( 63 ) \\ {Y}_{L} = - \frac{{y}_{L}}{{x}_{R , L} - {x}_{L , L}} S + H ; and & ( 64 ) \\ {Z}_{L} = [ 1 + \frac{S}{{x}_{R , L} - {x}_{L , L}} ] f . & ( 65 )\end{matrix}$$

Similarly, according to the formulas (50) to (52), the coordinate conversion is performed on i_{L,R} and i_{R,R} to obtain the 3D coordinates of the right eye 11 through calculation, that is, the coordinates in the formula (54), which are represented by the following formulas:

$$\begin{matrix}{X}_{R} = - ( \frac{{x}_{L , R}}{{x}_{R , R} - {x}_{L , R}} + \frac{1}{2} ) S ; & ( 66 ) \\ {Y}_{R} = - \frac{{y}_{R}}{{x}_{R , R} - {x}_{L , R}} S + H ; and & ( 67 ) \\ {Z}_{R} = [ 1 + \frac{S}{{x}_{R , R} - {x}_{L , R}} ] f . & ( 68 )\end{matrix}$$

5. Optimization Method of Viewing Condition

As the parallax barrier device has the optical feature of limited viewing freedom, the following settings of optimization conditions such as the viewing distance and viewing of the screen from front are required to achieve the objective of presenting the highest 3D image quality.

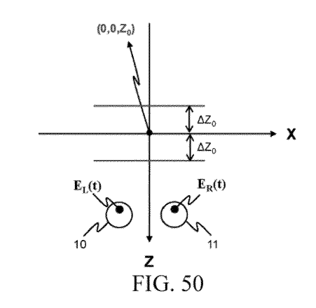

(1) Optimization Condition of Viewing Distance

|Z_{L}−Z₀|<ΔZ₀ (69); and

|Z_{R}−Z₀|<ΔZ₀ (70).

where ΔZ₀ is an offset of an allowable optimum viewing distance. The conditions set for the formulas (69) to (70), as shown in FIG. 50, may send an alarm message when it is detected that the viewer departs from the optimum viewing position and exceeds the preset range ΔZ₀ to require the positions of the eyes of the viewer to move to the optimum viewing distance Z₀.

(2) Optimization Condition of Viewing of Screen from Front

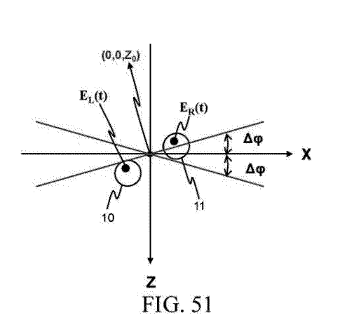

A. Exclude Side Viewing of 3D Image by Viewer with Turned Head

$$\begin{matrix}{cos}^{- 1} [ ( \hat{e} - \hat{e} \cdot {\hat{u}}_{y} ) \cdot {\hat{u}}_{x} ] < Δ ϕ ; and & ( 71 \text{-} 1 ) \\ \hat{e} = \frac{{E}_{R} - {E}_{L}}{{L}_{E}} & ( 71 \text{-} 2 )\end{matrix}$$

where E_{R} and E_{L} are regarded as vectors, ê is the unit vector along the left and right eye, ûₓ and û_{y} are the unit vector of the X-axis and Y-axis respectively, and Δφ is an offset of allowable horizontal viewing angle. The condition set in the formula (71), as shown in FIG. 51, is to send an alarm message when it is detected that a sightline of the viewer departs from the screen to the left or right and the deflective angle exceeds a preset angle Δφ, so as to require the viewer to modify the sightline to view the screen from front.

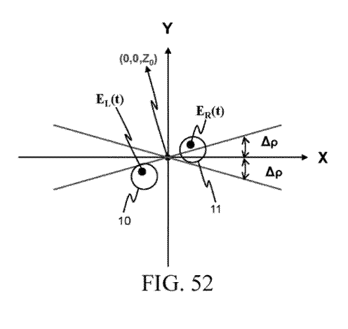

B. Exclude Slant Viewing of 3D Image by Viewer with Tilted Head

$$\begin{matrix}{cos}^{- 1} [ ( \hat{e} - \hat{e} \cdot {\hat{u}}_{z} ) \cdot {\hat{u}}_{x} ] < Δρ ; and & ( 72 \text{-} 1 ) \\ \hat{e} = \frac{{E}_{R} - {E}_{L}}{{L}_{E}} & ( 72 \text{-} 2 )\end{matrix}$$

where E_{R} and E_{L} are regarded as vectors, ê is the unit vector along the left and right eye, ûₓ and û_{z} are the unit vector of the X-axis and Z-axis respectively, and φρ is an offset of an allowable slant viewing angle. The condition set in the formula (72), as shown in FIG. 52, is to send an alarm message when it is detected that the viewer tilts the head to view the image and the tilted angle is greater than the preset angle Δρ, so as to require the viewer to modify the sightline to view the screen from front.

Therefore, according to the conditions in the formulas (69) to (72), the formulas (53) and (54) may have the following relation:

Y_{L}=Y_{R}=Y_{E} (73); and

Z_{L}=Z_{R}=Z₀ (74).

Therefore, eventually the coordinates of the left and right eyes become: E_{L}=(X_{L},Y_{E},Z₀) and E_{R}=(X_{R},Y_{E},Z₀). That is, the formulas (73) and (74) describe the optimum viewing condition of the viewer. When the viewing position of a viewer meets conditions that (1) the two eyes are kept at the same optimum viewing distance, (2) the two eyes are kept at the same height (that is, a horizontal status is kept), and (3) the two eyes view the screen from front, the viewer can view the 3D image with the optimum quality.

6. Optimum Alignment Method of Viewing Position and View

As described above, the so-called “optimum alignment between viewing position and view” is to obtain suitable Δ through a calculation of characteristic coordinates of left and right eyes, a calculation of coordinates of an optimum viewing point on an optimum viewing line, and a procedure of aligning a viewing point and a view according to the positions E_{L} and E_{R} acquired by the formulas (63) to (68) and the optimum viewing conditions required by the formulas (73) to (74), and then move the correct allowable viewing zone to the positions of the eyes of the viewer, so as to achieve the objectives of greatly improving the 3D image quality and the convenience of use.

First, the central line is redefined, so that let Y_{i,j,Δ}(x,y) replace all the primary central lines Y_{i,j}(x,y) and secondary central lines Y′_{i,j}(x,y), so as to define and divide the possible allowable viewing zones of the left and right eyes of the viewer. That is, Y_{i,jΔ=0}(x,y) is the originally defined primary central line; and Y_{i,j,Δ}(x,y) is the originally defined secondary central line. The central line Y_{i,j,Δ}(x,y) is represented as follows:

y=f(θ){x−[n×i−(n−1)/2+j−Δ/m]×L_{E}} (75).

When y=0, the coordinate values x(i,j,Δ) of the intersection point of Y_{i,j,Δ}(x,y) and the X-axis are obtained:

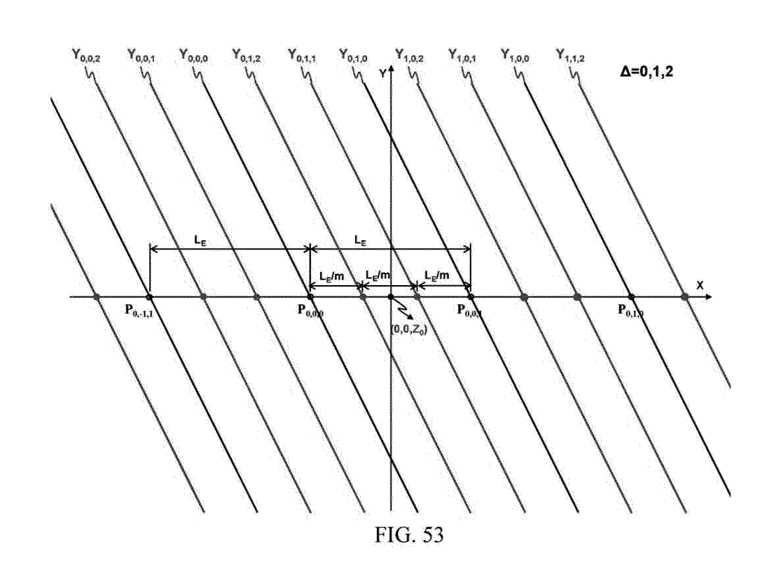

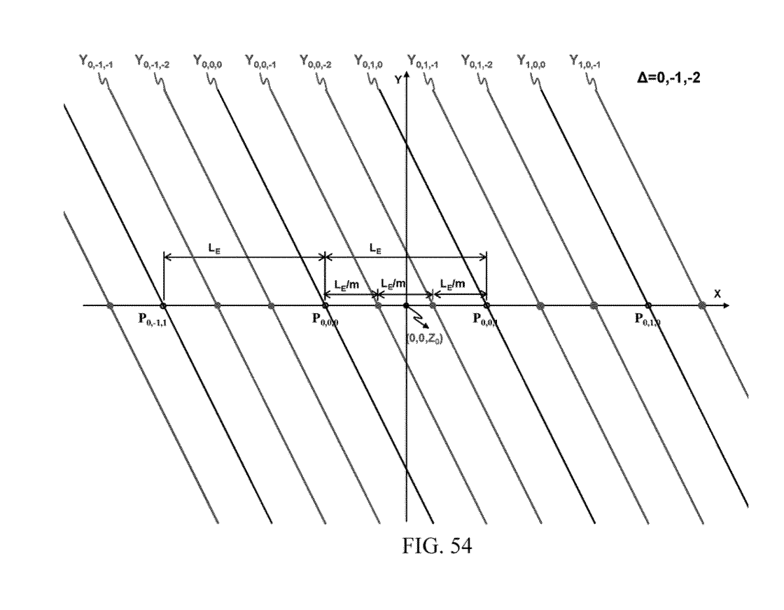

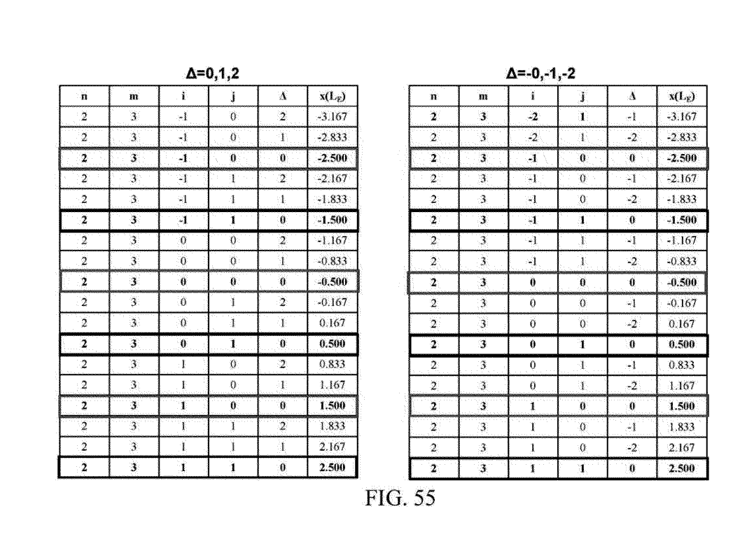

x(i,j,Δ)=[n×i−(n−1)/2+j−Δ/m]×L_{E} (76),

where f(θ), L_{E}, n(=2), m(=3), i, and j are as defined above. As shown in FIG. 53, Δ=0, 1, and 2 are substituted in the formula (75) to obtain Y_{i,j,Δ}(x,y). Therefore, through the operation of Δ>0, the objective of displacing all the primary central lines Y_{i,j,0}(x,y) to the left can be achieved. As shown in FIG. 54, Δ=−0, −1, and −2 are substituted in the formula (75) to obtain Y_{i,j,Δ}(x,y). Therefore, through the operation of Δ<0, the objective of displacing all the primary central lines Y_{i,j,0}(x,y) to the right can be achieved. As shown in FIG. 55, Δ=0, 1, and 2 and Δ=−0, −1, and −2 are substituted in the formula (76) to obtain the coordinate values x(i,j,Δ) of the intersection point between the Y_{i,j,Δ}(x,y) and the X-axis. No matter Δ=0, 1, 2 or Δ=−0, −1, −2, the obtained coordinate values x(i,j,Δ) of the intersection point are consistent. In addition, according to the above, x(i,j,Δ=0) is the primary optimum viewing point; and x(i,j,Δ≠0) is the secondary optimum viewing point. When Δ=±m (that is, ±3), all the primary central lines and the primary optimum viewing points move to the left (Δ=m) or to the right (Δ=−m) by a distance of IPD L_{E}. In the following, all the x(i,j,Δ=0) and x(i,j,Δ≠0) are referred to as optimum viewing points on the optimum viewing line in general.

As shown in FIG. 19, when the viewing positions of the left and right eyes 10 and 11 are respectively at the allowable viewing range 321 of the optimum viewing points inside the same viewing zone, the viewer can view a correct 3D image. When departing from the positions, the viewer enters the ghost image zones 322 and 323. In addition, when the viewing positions of the left and right eyes 10 and 11 are at the optimum viewing points in different viewing zones, the phenomenon of a pseudo stereoscopic image or a ghost image may occur. The phenomena occur between two adjacent primary optimum viewing points. Therefore, through the operation of |Δ|<m, the ghost image and pseudo stereoscopic image problems can be completely solved.

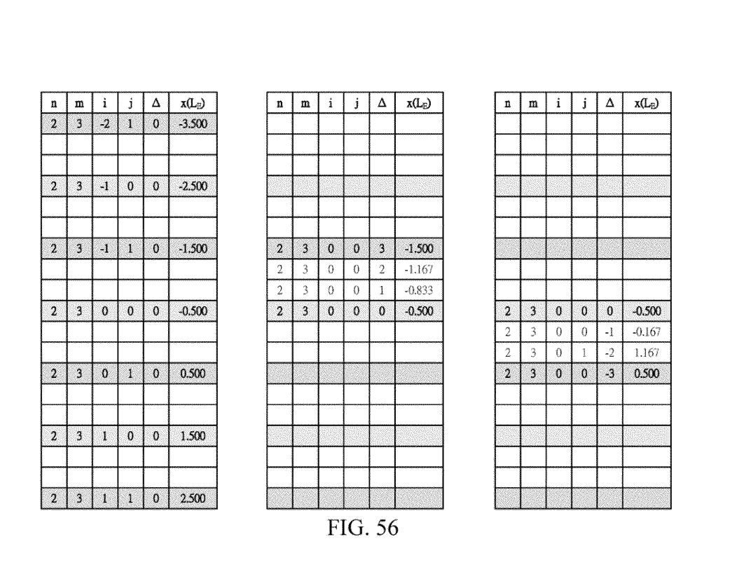

As shown in FIG. 56, for a primary optimum viewing point x(i=0,j=0,Δ=0) (on the left), the operation of |Δ|≦m is performed to achieve the objective of the displacement operation to the left or to the right. That is, Δ=0, 1, 2, and 3 (in the middle) and Δ=−0, −1, −2, and −3 (on the right) are substituted in the formula (76) to obtain the primary and secondary optimum viewing points. Therefore, after the positions of the left and right eyes are detected, as long as the closest Y_{i,j,Δ}(x,y) is found and then together with the operation of |Δ|≦m, the objective of 3D eye tracking can be achieved.

In the optimum alignment method of a viewing position and a view, for the positions of the two eyes having the optimum viewing conditions, according to the above central line and boundary lines of the allowable viewing range, first, the viewing zone numbers i, the closest view numbers j, and the closest horizontal displacement phases Δ respectively corresponding to the left and right eyes are found, and the practical implementation method is as follows.

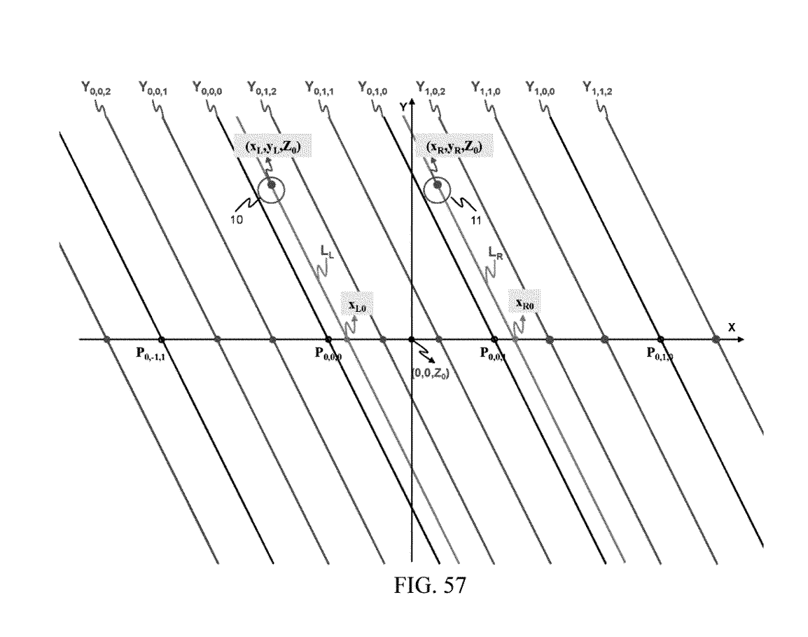

As shown in FIG. 57, first, slant lines L_{L} and L_{R}, having the same slant angle θ pass through the positions (X_{L},Y_{L},Z_{L}) and (X_{R},Y_{R},Z_{R}) of the left and right eyes respectively, intersect with the X-axis at x_{L0} and x_{R0}. x_{L0} and x_{R0} are referred to as characteristic coordinates of the left and right eyes. For the parallax barrier device having the right slantwise structure, x_{L0} and x_{R0} are obtained through the following calculation:

x_{L0}=X_{L}+tan(θ)×Y_{L} (77); and

x_{R0}=X_{R}+tan(θ)×Y_{R} (78).

For the parallax barrier device having the left slantwise structure, x_{L0} and x_{R0} are obtained through the following calculation:

x_{L0}=X_{L}−tan(θ)×Y_{L} (79); and

x_{R0}=X_{R}−tan(θ)×Y_{R} (80).

For the parallax barrier device having the vertical structure, x_{L0} and x_{R0} are obtained through the following calculation:

x_{L0}=X_{L} (81); and

X_{R0}=X_{R} (82).

Therefore, the characteristic coordinates x_{L0} and x_{R0} of the left and right eyes obtained by the formulas (77) to (82) are compared with the optimum viewing point x(i,j,Δ) on the optimum viewing line obtained by the formula (76) to find the values of the closest i, j, and Δ. Through the operation of Δ, the objective of 3D eye tracking is achieved. In the following, the practical processing procedure is illustrated and the procedure is referred to as a “procedure of aligning a viewing point and a view”.

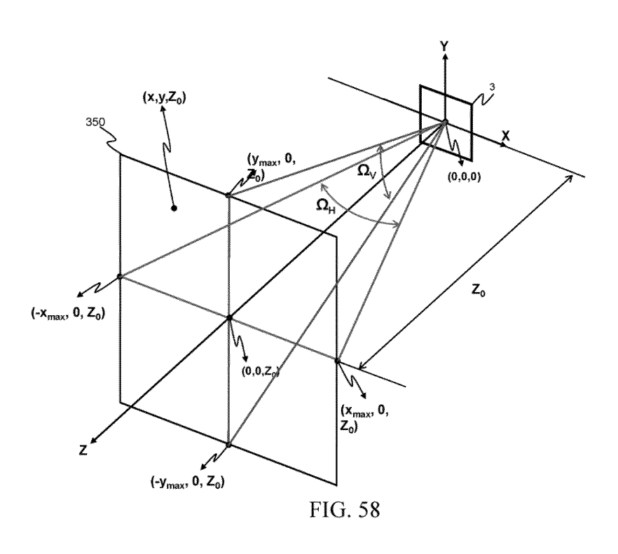

First, an “optimum viewable plane”, a “horizontal viewable angle”, and a “vertical viewable angle” are further defined. As shown in FIG. 58, the so-called “optimum viewable plane” refers to that on the optimum viewing plane, a viewable plane 350 with a limited area exists, only a limited number of optimum viewing points P_{k,i,j} exist on the plane, and the multiple optimum viewing points P_{k,i,j} may respectively provide, corresponding to the left and right eyes, a single view image with a low-ghost image and approximate brightness. The plane where the limited number of optimum viewing points P_{k,i,j} exist is the optimum viewable plane. For the coordinates (x,y,Z₀) of any arbitrary point that exists on the optimum viewing plane 350, the following relations exist:

−xₘₐₓ≦x≦xₘₐₓ (83); and

−yₘₐₓ≦y≦yₘₐₓ (84).

where xₘₐₓ and yₘₐₓ specify the range of the optimum viewable plane. That is, the viewer may view the 3D image with the best quality within the range defined by the formulas (83) and (84). Generally, the values of xₘₐₓ and yₘₐₓ are obtained through practical measurement (for example, cross-talk and brightness measurement) on the 3D image on the optimum viewing plane. In addition, according to xₘₐₓ and yₘₐₓ, a horizontal viewable angle Ω_{H} and a vertical viewable angle Ω_{V} are defined and represented by the following formulas:

Ω_{H}=2×tan⁻¹(xₘₐₓ/Z₀) (85); and

Ω_{V}=2×tan⁻¹(yₘₐₓ/Z₀) (86).

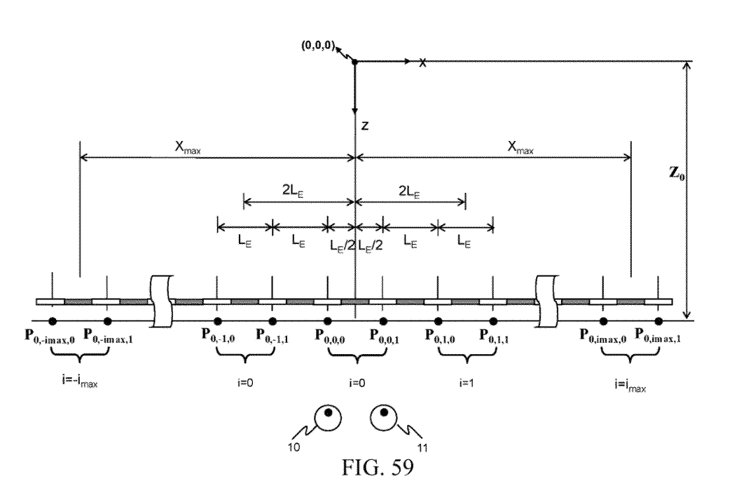

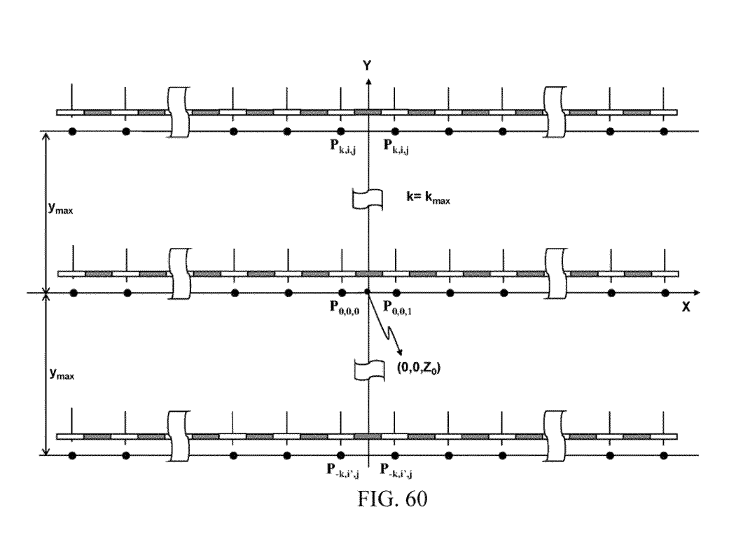

Definitely, the values of xₘₐₓ and yₘₐₓ may also respectively correspond to iₘₐₓ and kₘₐₓ, as shown in FIG. 59 and FIG. 60, so that optimum viewing points P_{k,i,j} exist on the optimum viewable plane, and the horizontal viewing zone number i and the vertical viewing zone number k in the P_{k,i,j} have the following relation:

|i|≦iₘₐₓ (87); and

|k|≦kₘₐₓ (88).

In addition, the following relations exist between xₘₐₓ and iₘₐₓ and between yₘₐₓ and kₘₐₓ:

xₘₐₓ=iₘₐₓ×n×L_{E} (89); and

yₘₐₓ=kₘₐₓ×L_{V} (90).

When a viewing angle of a viewer is smaller than Ω_{H} and Ω_{V}, the viewer can perceive a 3D image with a high quality. When the viewing angle becomes larger and exceeds Ω_{H} and Ω_{V}, due to the production and assembly errors of the view separation device, all the above linear optical features are ruined, not only the ghost image becomes much worse, but also the brightness difference of the images of the left and right eyes is excessively large, causing that the quality of the 3D image is low or even the 3D image cannot be viewed. In the following, for the procedure of aligning a viewing point and a view, the implementation steps are illustrated as follows according to the above definitions and assumption that the viewing conditions and positions of the viewer respectively satisfy the conditions required by the above formulas (69) to (74) and formulas (83) to (84).

As described above, the interval between x_{L0} and x_{R0} is the IPD L_{E}, so that only the left eye position x_{L0} or the right eye position x_{R0} needs to be compared with x(i,j,Δ) to find the optimum i, j, and Δ. To simplify the drawings and illustration, the left eye position x_{L0} is taken as an example for illustration.

Step 1: Verify whether the positions (x_{L},y_{E},z₀) and (x_{R},y_{E},z₀) of the left and right eyes are within the range of the optimum viewable plane. If the relation in the following formula is met, the process goes to Step 2; and if the relation of the following formula is not met, it indicates that the viewing positions depart from the range of the optimum viewable plane, and the process goes to Step 5.

|x_{L}|≦xₘₐₓ (91);

|x_{R}|≦xₘₐₓ (92); and

|y_{E}|≦yₘₐₓ (93).

Step 2: Set an initial value, as shown by the following formulas:

i=−iₘₐₓ (94); and

j=0 (95).

Step 3: Substitute i, j, and Δ in the formula (76) to calculate x(i,j,Δ).

Step 4: Compare x_{L0} and x(i,j,Δ) according to the following formula:

|x_{L0}−x(i,j,Δ)|≦L_{E}/2m (96).

Case 1: If a group of parameters (i, j, and Δ) are found to meet the relation of the formula (96), then substitute Δ in the formula (3) or (4) and it indicates that the 3D eye tracking is successful, and the process goes to Step 5.

Case 2: If no group of parameters (i, j, and Δ) is found to meet the relation in the formula (96), then set:

j=j+2 (97).

If j<n (that is, j does not exceed the viewing zone i), then the process goes to Step 3.

If j≧n (that is, j already exceeds the viewing zone i) then set:

i=i+1 (98); and

j=0 (99).

If i≦iₘₐₓ, then the process goes to Step 3.

If i>iₘₐₓ, then it indicates that the viewing position departs from the viewable angle range, and the process goes to Step 5.

Step 5: End comparison.

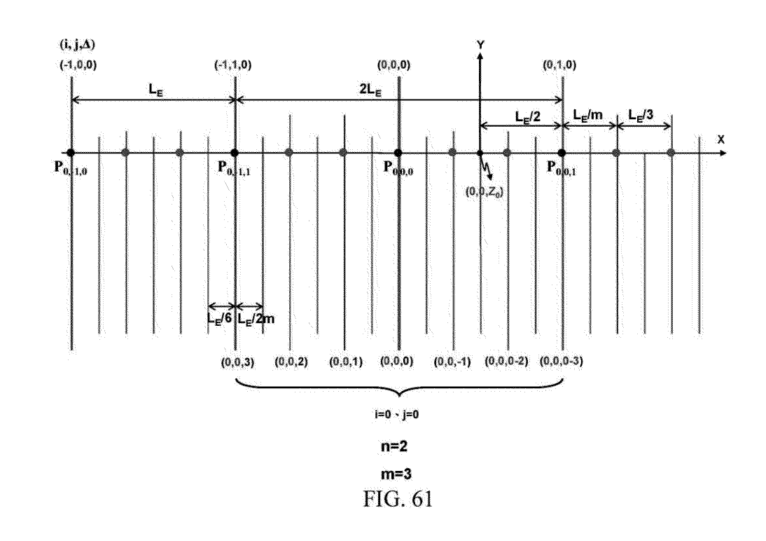

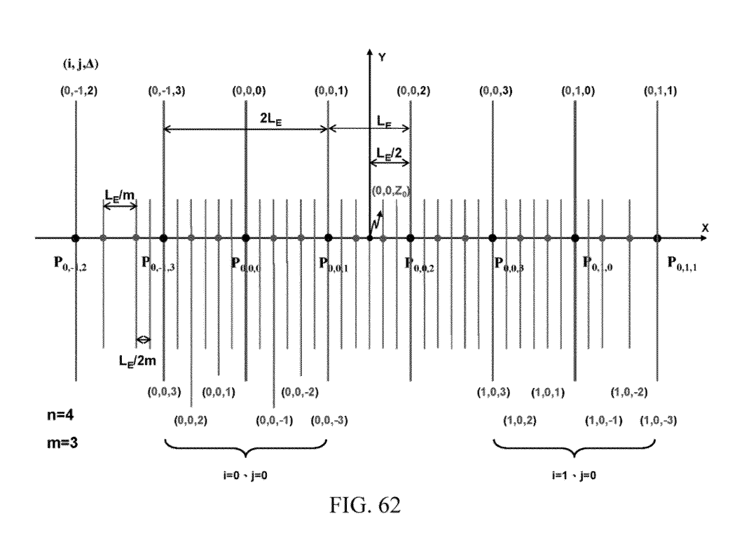

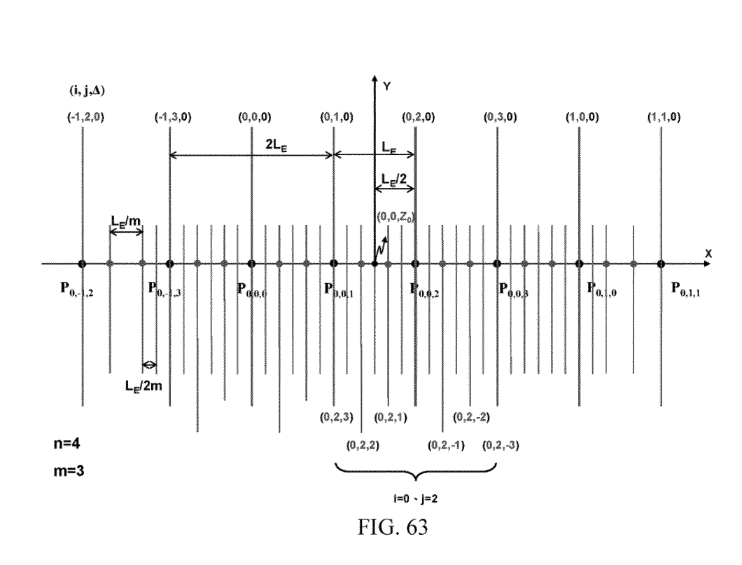

For the comparing operation of the formula (96), as shown in FIG. 61, the above 2-view display (n=2, m=3) and the viewing zone of i=0, j=0 are taken as an example to compare x_{L0} with x(0,0,3), x(0,0,2), x(0,0,1), x(0,0,0), x(0,0,−1), x(0,0,−2), and x(0,0,−3). Therefore, as long as x_{L0} meets the condition of x(0,0,3)−L_{E}/6≦x_{L0}≦x(0,0,−3)+L_{E}/6, the corresponding value of Δ can be found. As shown in FIG. 62, the above 4-view display (n=4, m=3) and the viewing zones of i=0, j=0 and i=1, j=0 are taken as an example to perform the operation of comparison of x_{L0}. As shown in FIG. 63, the above 4-view display (n=4, m=3) and the viewing zone of i=0 and j=2 are taken as an example to perform the operation of comparison of x_{L0}.

Definitely, the procedure of aligning a viewing point and a view may also perform the operation of comparison with the right eye position x_{R0}. However, for the initial value of j at the formula (95) needs to be set j=1; and in the formula (96), x_{R0} replaces x_{L0}, as shown in the following formula:

|x_{R0}−x(i_{R},j_{R},Δ)|<L_{E}/m (100).

For j in the formula (99), when j already exceeds the viewing zone i, then set j=1.

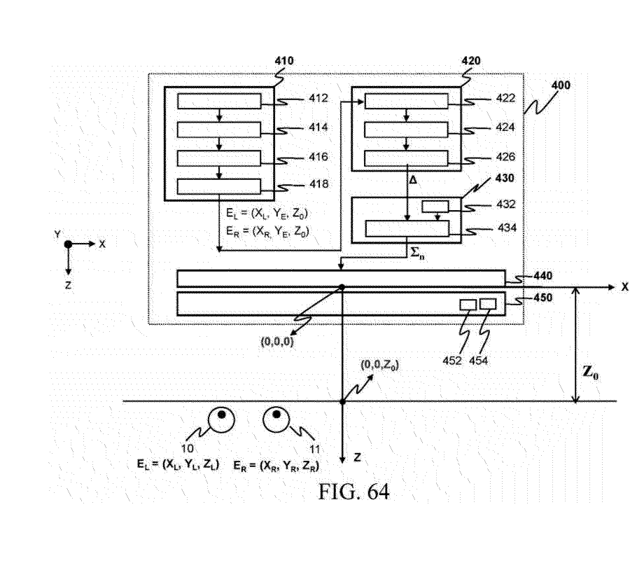

FIG. 64 is a schematic view according to an embodiment of the present invention. The method of displaying a multi-view 3D image 400 of the present invention is mainly formed of a real-time detection method of a viewing position 410, an optimum alignment method of a viewing position and a view 420, a dynamic multi-view 3D image combination method 430, a flat-panel display screen 440, and a static parallax barrier device 450.

The real-time detection method of a viewing position 410, as described above, mainly uses a pair of left and right camera devices 412 to detect central positions of left and right eyeballs (or pupils) in the left and right image coordinate systems in the 2D images retrieved from the left and right camera devices through photography and image processing (as shown by the formulas (55) to (58)), and then uses procedures corresponding to left and right images 414 (as shown by the formulas (59) to (61)), a procedure of conversion and calculation of 3D coordinates 416 (as shown by the formulas (63) to (68)), and a procedure of optimizing a viewing condition 418 (as shown by the formulas (69) to (74)) to obtain and output 3D positions of left and right eyes E_{L}=(X_{L},Y_{E},Z₀) and E_{R}=(X_{R},Y_{E},Z₀).

The optimum alignment method of a viewing position and a view 420, as described above, mainly, according to the 3D positions of the left and right eyes E_{L} and E_{R}, uses a procedure of calculating characteristic coordinates of left and right eyes 422 (as shown in the formulas (77) to (82)), a procedure of calculating the coordinates of an optimum viewing point on an optimum viewing line 424 (as shown by the formula (76)), and a procedure of aligning a viewing point and a view 426, so as to calculate and output a suitable Δ.

The dynamic multi-view 3D image combination method 430, as described above, mainly generates a multi-view combined 3D image Σₙ for a multi-view image 432 (as shown by the formula (1)) according to Δ and a multi-view 3D image combination procedure 432 (as shown by the formulas (42) to (43)).

The flat-panel display screen 440, as described above, mainly receives and displays the multi-view combined 3D image Σₙ.

For the multi-view combined 3D image Σₙ, the static parallax barrier device 450, as described above, provides an optimum viewing plane at an optimum viewing distance and also provides multiple optimum viewing points on the optimum viewing plane, and at the optimum viewing points, performs the optical effect of view separation, so as to achieve the objective of respectively presenting a single view image. In addition, for the optical structure of the parallax barrier, mainly a design method of a static parallax barrier device 452 (as shown by the formulas (6) to (17) and the formulas (23) to (31)) and an optimization method of viewing freedom 454 (as shown by the formulas (47) and (49)) are used to achieve the objective of optimizing the design. Therefore, on the optimum viewable plane, the view separation effect is performed on the multi-view combined 3D image Σₙ (t), and the correct left and right images are projected to the left and right eyes 10 and 11 of the viewer to achieve the objective of displaying a 3D image.

The “procedure” refers to a software program capable of processing the calculation of all related formulas in the present invention, and the software program is executed by a computing device such as a microprocessor or a digital signal processor (DSP).

In conclusion, the present invention is a method of displaying a 3D image, which mainly proposes, when a flat-panel display screen and a static parallax barrier device are used to display a 3D image, (1) a design method of a static parallax barrier device, (2) a dynamic multi-view 3D image combination method, (3) an optimization method of viewing freedom, (4) a real-time detection method of a viewing position, (5) a viewing condition optimization method, and (6) an optimum alignment method of a viewing position and a view, so as to effectively solve the problems of the ghost image, the pseudo stereoscopic image, and the insufficient viewing freedom in the horizontal and vertical directions on the optimum viewable plane, and achieve the objectives of greatly improving the 3D image quality and the convenience of use.

The above descriptions are merely preferred embodiments of the present invention, and are not intended to limit the scope of the present invention. Various modifications and variations made within the appended claims of the present invention shall fall within the scope of the invention. In addition, the methods disclosed by the present invention, especially (2) the dynamic multi-view 3D image combination method, (4) the real-time detection method of a viewing position, and (5) the optimum alignment method of a viewing position and a view, are also applicable to other static view separation devices (for example, a lenticular lens array) and dynamic view separation devices. Thus, we will be most grateful if a patent right is granted upon careful examination of the Examiner.

The invention being thus described, it will be obvious that the same is varied in many ways. Such variations are not to be regarded as a departure from the spirit and scope of the invention, and all such modifications as would be obvious to one skilled in the art are intended to be included within the scope of the following claims.

What is claimed is:

1. A method of displaying a 3D image, applied to eliminate defects of auto-stereoscopic display, and through implementation of the following methods and components, to effectively solve problems of a ghost image, a pseudo stereoscopic image, and insufficient viewing freedom in horizontal and vertical directions on an optimum viewable plane, thereby achieving objectives of greatly improving 3D image quality and the convenience of use, the method comprising:
a real-time detection method of a viewing position, using a pair of left and right camera devices, through photography and image processing, to detect central positions (i_{L,L} and i_{L,R}) of left and right eyeballs (or pupils) and central positions (i_{R,L} and i_{R,R}) of the right eyeball (or pupil) in 2D images obtained from the left and right camera devices in left and right image coordinate systems, and using a procedure of left/right image correspondence, a procedure of conversion and calculation of 3D coordinates, and a procedure of optimizing a viewing condition to obtain and output a 3D position of the left eye E_{L}=(X_{L},Y_{E},Z₀) and a 3D position of the right eye E_{R}=(X_{R},Y_{E},Z₀) in a screen coordinate system;
an optimum alignment method of a viewing position and a view, according to the 3D positions E_{L} and E_{R} of the left and right eyes, calculating and outputting a horizontal displacement phase Δ through a procedure of calculating characteristic coordinates of the left and right eyes, a procedure of calculating coordinates of an optimum viewing point on an optimum viewing line, and a procedure of aligning a viewing point and a view;
a dynamic multi-view 3D image combination method, generating a multi-view combined 3D image Σₙ for a multi-view image according to the horizontal displacement phase Δ and a multi-view 3D image combination procedure;
a flat-panel display screen, receiving and displaying the multi-view combined 3D image Σₙ; and
a static parallax barrier device, being a static view separation device, providing an optimum viewing plane at an optimum viewing distance for the multi-view combined 3D image Σₙ, providing multiple optimum viewing points on the optimum viewing plane, and performing an optical effect of view separation at the optimum viewing points to achieve an objective of respectively presenting a single view image, wherein an optical structure of the parallax barrier achieves an objective of an optimized design through a design method of a static parallax barrier device and an optimization method of viewing freedom.

2. The method of displaying a 3D image according to claim 1, wherein the flat-panel display screen is formed of a liquid crystal screen, plasma screen, or organic light emitting diode (OLED) screen; the screen is formed of N×M RGB sub-pixels or N×M RGBW sub-pixels, where N is a total number of sub-pixels in a horizontal direction (X-axis) of the display screen, M is a total number of sub-pixels in a vertical direction (Y-axis) of the display screen, R is red, G is green, B is blue, and W is white; the single sub-pixel has a size of P_{H}×P_{V}, where P_{H} is a horizontal width of the sub-pixel, and P_{V} is a vertical height of the sub-pixel; in addition, a screen coordinate system XYZ is set, and an origin of the screen coordinate system is located at the center of the screen; an X-axis of the screen coordinate system is set at the horizontal direction; a Y-axis of the screen coordinate system is set at the vertical direction; and a Z-axis of the screen coordinate system is set at a direction perpendicular to the display screen.

3. The method of displaying a 3D image according to claim 2, wherein configuration of the sub-pixels is RGB in horizontal strip configuration, RGB in vertical strip configuration, RGB in mosaic configuration, RGB in delta configuration or RGBW in Pentile configuration.

4. The method of displaying a 3D image according to claim 1, wherein the multi-view image is formed of n single view images Vₖ, and is represented by the following formula:
$${V}_{k} = {\sum }_{i = 0}^{M - 1} {\sum }_{j = 0}^{N - 1} {V}_{k}^{i , j} ,$$
where the parameters are defined as follows:
Vₖ^{i,j}: image data of a sub-pixel at a position (i,j) in an image Vₖ;
N: a total number of sub-pixels in the horizontal direction of the display screen;
M: a total number of sub-pixels in the vertical direction of the display screen;
j and i: indexes of horizontal and vertical positions of a single sub-pixel, where 0≦j≦N−1 and 0≦i≦M−1;
n: a total view number, where n≧2; and
k: a view number, where 0≦k<n.

5. The method of displaying a 3D image according to claim 1, wherein the multi-view 3D image combination procedure generates the multi-view combined 3D image Σₙ for the multi-view image through the following formula:
$${Σ}_{n} = {\sum }_{i = 0}^{M - 1} {\sum }_{j = 0}^{N - 1} {V}_{Λ}^{i , j} , \\ where \\ Λ = Mod [ int ( \frac{j - Π \times int ( \frac{i + Δ}{Q} )}{m} ) , n ] , \qquad ( 1 )$$
and
the parameters and functions int and Mod are defined as follows:
V_{Λ}^{i,j}: image data of a sub-pixel at a position (i,j) in an image V_{Λ};
Λ: a view number, where Λ<n;
n: a total view number;
m: the number of sub-pixels in a horizontal smallest display unit;
Q: the number of sub-pixels in a vertical smallest display unit;
Δ: a horizontal displacement phase;
Π: a horizontal displacement amplitude;
j and i: indexes of horizontal and vertical positions of a single sub-pixel, where 0≦j≦N−1 and 0≦i≦M−1;
int: a function of rounding; and
Mod: a function of taking a remainder.

6. The method of displaying a 3D image according to claim 1, wherein the multi-view 3D image combination procedure generates the multi-view combined 3D image Σₙ for the multi-view image through the following formula:
$${Σ}_{n} = {\sum }_{i = 0}^{M - 1} {\sum }_{j = 0}^{N - 1} {V}_{Λ}^{i , j} , \\ where \\ Λ = Mod [ int ( \frac{( N - 1 ) - j - Π \times int ( \frac{i + Δ}{Q} )}{m} ) , n ] , \qquad ( 2 )$$
and
the parameters and functions int and Mod are defined as follows:
V_{Λ}^{i,j}: image data of a sub-pixel at a position (i,j) in an image V_{Λ};
Λ: a view number, where Λ<n;
n: a total view number;
m: the number of sub-pixels in a horizontal smallest display unit;
Q: the number of sub-pixels in a vertical smallest display unit;
Δ: a horizontal displacement phase;
Π: a horizontal displacement amplitude;
j and i: indexes of horizontal and vertical positions of a single sub-pixel, where 0≦j≦N−1 and 0≦i≦M−1;
int: a function of rounding; and
Mod: a function of taking a remainder.

7. The method of displaying a 3D image according to claim 1, wherein the design method of a static parallax barrier device designs a basic optical structure in the horizontal direction according to the following formulas:
$${B}_{H} = \frac{{mP}_{H} {L}_{H}}{{mP}_{H} + {L}_{H}} = \frac{{Z}_{0} - {L}_{B}}{{Z}_{0}} {mP}_{H} ;$$
$${L}_{H} = \frac{{mP}_{H} {B}_{H}}{{mP}_{H} - {B}_{H}} = \frac{{Z}_{0}}{{L}_{B}} {B}_{H} ;$$
$${\overline{B}}_{H} = ( n - 1 ) {B}_{H} ;$$
$$tan θ = \frac{{P}_{H}}{{QP}_{V}} ;$$
$${Z}_{0} = \frac{{mP}_{H}}{{mP}_{H} - {B}_{H}} {L}_{B} ,$$
where all the parameters are defined as follows:
B_{H}: a horizontal width of a transparent component;
B̅_{H}: a horizontal width of an opaque component;
L_{H}: a horizontal interval between two optimum viewing points;
θ: a slant angle of a slantwise strip parallax barrier;
Z₀: an optimum viewing distance;
L_{B}: a disposed distance of the slantwise strip parallax barrier;
P_{H}: a horizontal width of a sub-pixel;
n: a total view number;
m: the number of sub-pixels in a horizontal smallest display unit; and
Q: the number of sub-pixels in a vertical smallest display unit.

8. The method of displaying a 3D image according to claim 7, wherein the horizontal interval between two optimum viewing points L_{H} and an interpupillary distance (IPD) L_{E} have the following relation:
L_{H}=L_{E}.

9. The method of displaying a 3D image according to claim 7, wherein the optimized design of the horizontal aperture width of the transparent component B_{H} is to perform reduction processing on the horizontal aperture width of the transparent component to obtain an allowable horizontal viewing range ΔX_{VF}, where the allowable horizontal viewing range ΔX_{VF} and the reducing amount of the horizontal aperture width of the transparent component ΔB_{H} have the following relation:
ΔX_{VF}=Rₓ×L_{H},
where
Rₓ=ΔB_{H}/B_{H}, and
the parameters are defined as follows:
Rₓ: horizontal viewing freedom, where 0≦Rₓ≦1; and
L_{H}: a horizontal interval between two optimum viewing points.

10. The method of displaying a 3D image according to claim 1, wherein the design method of a static parallax barrier device designs a basic optical structure in the vertical direction according to the following formulas:
$${B}_{V} = \frac{{Z}_{0} - {L}_{B}}{{Z}_{0}} {mQP}_{V} ; and$$
$${L}_{V} = \frac{{mQP}_{V} {B}_{V}}{{mQP}_{V} - {B}_{V}} ;$$
where the parameters are defined as follows:
B_{V}: a vertical aperture width of a transparent component;
L_{V}: a vertical interval between two optimum viewing points;
Z₀: an optimum viewing distance;
L_{B}: a disposed distance of a slantwise strip parallax barrier;
m: the number of sub-pixels in a horizontal smallest display unit;
Q: the number of sub-pixels in a vertical smallest display unit; and
P_{V}: a vertical height of a sub-pixel.

11. The method of displaying a 3D image according to claim 10, wherein the vertical aperture width of the transparent component B_{V} and the horizontal width of the transparent component B_{H} have the following relation:
$$\frac{{B}_{V}}{{B}_{H}} = Q \frac{{P}_{V}}{{P}_{H}} ,$$
where the parameters are defined as follows:
Q: the number of sub-pixels in a vertical smallest display unit;
P_{V}: a vertical height of a sub-pixel; and
P_{H}: a horizontal width of a sub-pixel.

12. The method of displaying a 3D image according to claim 10, wherein the vertical interval between two optimum viewing points L_{V} and the horizontal interval between two optimum viewing points L_{H} have the following relation:
$$\frac{{L}_{V}}{{L}_{H}} = Q \frac{{P}_{V}}{{P}_{H}} ; and$$
$${L}_{V} = \frac{{L}_{H}}{tan θ} ,$$
where the parameters are defined as follows:
Q: the number of sub-pixels in a vertical smallest display unit;
P_{V}: a vertical height of a sub-pixel;
P_{H}: a horizontal width of a sub-pixel; and
θ: a slant angle of a slantwise strip parallax barrier.

13. The method of displaying a 3D image according to claim 10, wherein the optimized design of the vertical aperture width of the transparent component B_{V} is to perform reduction processing on the vertical aperture width of the transparent component to obtain an allowable vertical viewing range ΔY_{VF}, where the allowable vertical viewing range ΔY_{VF} and the reducing amount of the vertical aperture width of the transparent component ΔB_{V} have the following relation:
ΔY_{VF}=R_{Y}×L_{V},
where
R_{Y}=ΔB_{V}/B_{V}, and
the parameters are defined as follows:
R_{Y}: vertical viewing freedom, where 0≦Rₓ≦1; and
L_{V}: a vertical interval between two optimum viewing points.

14. The method of displaying a 3D image according to claim 13, wherein the vertical viewing freedom R_{Y} and the horizontal viewing freedom Rₓ have the following relation:
R_{Y}=R_{X}.

15. The method of displaying a 3D image according to claim 13, wherein the allowable vertical viewing range ΔY_{VF} and the allowable horizontal viewing range ΔX_{VF} have the following relation:
$$\frac{Δ {X}_{VF}}{Δ {Y}_{VF}} = tan θ .$$

16. The method of displaying a 3D image according to claim 1, wherein the optimization method of viewing freedom is to enable the width of an overlapping zone ΔX_{OL}, between adjacent two allowable viewing zones to meet the relation in the following formula:
ΔX_{OL}=(Rₓ−1/m)×L_{H}>0,
where the parameters are defined as follows:
Rₓ: horizontal viewing freedom;
m: the number of sub-pixels in a horizontal smallest display unit; and
L_{H}: a horizontal interval between two optimum viewing points.

17. The method of displaying a 3D image according to claim 1, wherein the static parallax barrier device is formed of the structure of a vertical strip parallax barrier, a slantwise strip parallax barrier or a slant-and-step parallax barrier.

18. The method of displaying a 3D image according to claim 1, wherein the positions of the multiple optimum viewing points are represented by P_{k,i,j}(x_{c},y_{c},Z₀) in the screen coordinate system and have the relation in the following formulas:
x_{c}=[n×i−(n−1)/2+j−k]×L_{H}; and
y_{c}=k×L_{V}, and
in addition, the multiple optimum viewing points P_{k,i,j}(x_{c},y_{c},Z₀) have an allowable horizontal viewing range ΔX_{VF} and an allowable vertical viewing range ΔY_{VF}, and are distributed along the slant angle θ according to the slantwise feature of the optical structure to form an allowable viewing zone and a ghost image zone featuring repetitively interlacing configuration in the horizontal direction, where the allowable viewing zone is formed of a central line Y_{i,j}(x,y) and two boundary lines Y_{i,j}⁺(x,y) and Y_{i,j}⁻(x,y) and has the relation in the following formula:
the central line Y_{i,j}(x,y), represented by the following formula:
y=f(θ){x−[n×i−(n−1)/2+j]×L_{H}} (3),
the right boundary line Y_{i,j}⁺(x,y), represented by the following formula:
y=f(θ){x−[n×i−(n−1)/2+j+Rₓ/2]×L_{H}} (4),
the left boundary line Y_{i,j}⁻(x,y), represented by the following formula:
y=f(θ){x−[n×i−(n−1)/2+j−Rₓ/2]×L_{H}} (5),
where for a parallax barrier device having a right slantwise structure, f(θ) has the relation in the following formula:
f(θ)=−tan θ;
for a parallax barrier device having a left slantwise structure, f(θ) is represented by the following formula:
f(θ)=tan θ;
for a parallax barrier device having a vertical structure, θ=0, and f(θ)=0, Y_{i,j}(x,y), Y_{i,j}⁺(x,y), and Y_{i,j}⁻(x,y) become vertical lines, which are respectively represented by the following formulas:
x=[n×i−(n−1)/2+j]×L_{H} (6);
x=[n×i−(n−1)/2+j+Rₓ/2]×L_{H} (7); and
x=[n×i−(n−1)/2+j−Rₓ/2]×L_{H} (8),
in addition, for the central line Y_{i,j}(x,y) and the boundary lines Y_{i,j}⁺(x,y) and Y_{i,j}⁻(x,y) described in the formulas (3) to (5), when y=0, the value of x is obtained, as shown in the formulas (6) to (8); that is, the parallax barrier devices having the slantwise structure and the vertical structure achieve the same optical effect of view separation on the horizontal line of z=Z₀ and y=0, where the horizontal line of z=Z₀ and y=0 is an optimum viewing line;
in addition, in the above formulas, the used parameters are defined as follows:
Z₀: an optimum viewing distance;
n: a total view number;
i: a horizontal viewing zone number;
j: a view number;
k: a vertical viewing zone number;
L_{H}: a horizontal interval between two optimum viewing points;
L_{V}: a vertical interval between two optimum viewing points; and
θ: a slant angle of a slantwise strip parallax barrier.

19. The method of displaying a 3D image according to claim 1, wherein the pair of left and right camera devices have the same optical imaging systems, that is, have optical imaging lenses with the same focal length f and the same image sensors, and a left image coordinate system X_{L}Y_{L}Z_{L} and a right image coordinate system X_{R}Y_{R}Z_{R} are respectively disposed on the left and right camera device; origins of the two image coordinate systems are respectively disposed at the centers of the image sensors of the left and right camera devices, and coordinate axes of the two image coordinate systems and the screen coordinate system are parallel, and in the screen coordinate system, the coordinates of the origins of the two image coordinate systems are respectively (−S/2,H,0) and (S/2,H,0), where S is an interval between the optical axes of the left and right camera devices, and H is the height of the device; in addition, Z_{L} and Z_{R} are respectively set at the optical axes of the left and right camera devices, that is, the optical axes of the left and right camera devices are parallel to the Z-axis, and central coordinates of the left and right eyeballs (or pupils) are represented by the following formula:
in the left image coordinate system, the central coordinates of the left eyeball (or pupil) are:
i_{L,L}=(x_{L,L},y_{L,L},0);
in the left image coordinate system, the central coordinates of the right eyeball (or pupil) are:
i_{L,R}=(x_{L,R},y_{L,R},0);
in the right image coordinate system, the central coordinates of the left eyeball (or pupil) are:
i_{R,L}=(x_{R,L},y_{R,L},0);
in the right image coordinate system, the central coordinates of the right eyeball (or pupil) are:
i_{R,R}=(x_{R,R},y_{R,R},0); and
in addition, as the left and right camera devices have the same optical features, y_{L,L}=y_{R,L}=y_{L} and y_{L,R}=y_{R,R}=y_{R}.

20. The method of displaying a 3D image according to claim 1, wherein the procedures of left/right image correspondence is to perform corresponding processing on central coordinates of the left and right eyeballs in the left and right image coordinate systems and 3D coordinates of the left and right eyes in the screen coordinate system, that is, the left eye position E_{L} corresponds to i_{L,L} and i_{R,L}; and the right eye position E_{R} corresponds to i_{L,R} and i_{R,R}.

21. The method of displaying a 3D image according to claim 1, wherein the procedure of conversion and calculation of 3D coordinates is to convert the left eye coordinates i_{L,L} and i_{R,L} imaged in the image coordinate system into 3D coordinates E_{L}=(X_{L},Y_{L},Z_{L}) in the screen coordinate system and convert the right eye coordinates i_{L,R} and i_{R,R} into 3D coordinates E_{R}=(X_{R},Y_{R},Z_{R}) in the screen coordinate system through a coordinate conversion between the image coordinate system and the screen coordinate system.

22. The method of displaying a 3D image according to claim 21, wherein the coordinate conversion between the image coordinate system and the screen coordinate system has the following relation:
3D coordinates of the left eye:
$${X}_{L} = - ( \frac{{x}_{L , L}}{{x}_{R , L} - {x}_{L , L}} + \frac{1}{2} ) S ;$$
$${Y}_{L} = - \frac{{y}_{L}}{{x}_{R , L} - {x}_{L , L}} S + H ; and$$
$${Z}_{L} = [ 1 + \frac{S}{{x}_{R , L} - {x}_{L , L}} ] f ; and$$
3D coordinates of the right eye:
$${X}_{R} = - ( \frac{{x}_{L , R}}{{x}_{R , R} - {x}_{L , R}} + \frac{1}{2} ) S ;$$
$${Y}_{R} = - \frac{{y}_{R}}{{x}_{R , R} - {x}_{L , R}} S + H ; and$$
$${Z}_{R} = [ 1 + \frac{S}{{x}_{R , R} - {x}_{L , R}} ] f .$$

23. The method of displaying a 3D image according to claim 1, wherein the procedure of optimizing a viewing condition is mainly formed of the following optimum viewing conditions:
a viewing distance optimization condition, formed of the conditions in the following formulas:

|Z_{L}−Z₀|<ΔZ₀; and

|Z_{R}−Z₀|<ΔZ₀,
where ΔZ₀ is an offset of the allowable optimum viewing distance, that is, the differences between Z_{L} and Z₀ and between Z_{R} and Z₀ need to be smaller than ΔZ₀; and
an optimization condition of viewing the screen from front, formed of the conditions in the following formulas:
$${cos}^{- 1} [ ( \hat{e} - \hat{e} \cdot {\hat{u}}_{y} ) \cdot {\hat{u}}_{x} ] < Δϕ$$
$${cos}^{- 1} [ ( \hat{e} - \hat{e} \cdot {\hat{u}}_{z} ) \cdot {\hat{u}}_{x} ] < Δ ρ$$
$$\hat{e} = \frac{{E}_{R} - {E}_{L}}{{L}_{E}}$$
where E_{R} and E_{L} are regarded as vectors, ê is the unit vector along the left and right eye, ûₓ, û_{y} and û_{z} are the unit vector of the X-axis, Y-axis and Z-axis respectively, and Δφ is an offset of an allowable horizontal viewing angle, Δρ is an offset of an allowable slant viewing angle, that is, the left and right eyes need to view the screen from front, the offset of the horizontal viewing angle needs to be smaller than Δφ, and the offset of the slant viewing angle needs to be smaller than Δρ;
therefore, the conditions are further simplified and represented as follows:
Y_{L}=Y_{R}=Y_{E}; and
Z_{L}=Z_{R}=Z₀,
that is, the optimization of the viewing condition specifies the viewing position of a viewer, and when the viewing position satisfies conditions that (a) the two eyes are kept at the same optimum viewing distance, (b) the two eyes are kept at the same height (that is, a horizontal status is kept), and (c) the two eyes need to view the screen from front, the 3D image with the optimum quality is viewed.

24. The method of displaying a 3D image according to claim 1, wherein the left and right camera devices are embedded in or externally disposed on a casing of a device comprising a mobile phone, a digital camera, a video camera, a game console, a tablet computer, a notebook computer, a monitor, a television, and a 3D television.

25. The method of displaying a 3D image according to claim 1, wherein for the procedure of calculating characteristic coordinates of the left and right eyes, the calculation method is to make slant lines L_{L} and L_{R} having the same slant angle θ to respectively pass through positions of the left and right eyes (X_{L},Y_{L},Z_{L}) and (X_{R},Y_{R},Z_{R}), and respectively intersect with the X-axis at x_{L0}, x_{R0}, where x_{L0} and x_{R0} have the following relation:
for the parallax barrier device having the right slantwise structure, x_{L0} and x_{R0} are obtained through the following calculation:
x_{L0}=X_{L}+tan(θ)×Y_{L}; and
x_{R0}=X_{R}+tan(θ)×Y_{R};
for the parallax barrier device having the left slantwise structure, x_{L0} and x_{R0} are obtained through the following calculation:
x_{L0}=X_{L}−tan(θ)×Y_{L}; and
x_{R0}=X_{R}−tan(θ)×Y_{R}; and
for the parallax barrier device having the vertical structure, x_{L0} and x_{R0} are obtained through the following calculation:
x_{L0}=X_{L}; and
X_{R0}=X_{R}.

26. The method of displaying a 3D image according to claim 1, wherein the procedure of calculating the coordinates of an optimum viewing point on an optimum viewing line is to calculate coordinates x(i,j,Δ) of the optimum viewing point through the following formula:
x(i,jΔ)=[n×i−(n−1)/2+j−Δ/m]×L_{H},
where the parameters are defined as follows:
n: a total view number;
m: the number of sub-pixels in a horizontal smallest display unit;
i: a horizontal viewing zone number;
j: a view number;
Δ: a horizontal displacement phase; and
L_{H}: a horizontal interval between two optimum viewing points.

27. The method of displaying a 3D image according to claim 1, wherein the procedure of aligning a viewing point and a view comprises the following steps when the position of the left eye is used as a reference:
Step 1: verifying whether the positions of the left and right eyes (X_{L},Y_{E},Z₀) and (X_{R},Y_{E},Z₀) are within the range of the optimum viewable plane, wherein if the relation in the following formulas is satisfied, the process goes to Step 2; and if the relation of the following formulas is not satisfied, it indicates that the viewing position departs from the range of the optimum viewable plane, and the process goes to Step 5;

|X_{L}|≦xₘₐₓ;

|X_{R}|≦xₘₐₓ; and

|Y_{E}|≦yₘₐₓ;
Step 2: setting an initial value, as shown in the following formulas:
i=−iₘₐₓ; and
j=0;
Step 3: calculating x(i,j,Δ);
Step 4: comparing x_{L0} and x(i,j,Δ), as shown in the following formula:

|x_{L0}−x(i,j,Δ)|≦L_{H}/2m (9),
Case 1: if a group of parameters (i, j, and Δ) satisfying the relation in the formula (9) are found, substitute Δ in the formula (1) or (2), and it indicates that the 3D eye tracking is successful, and the process goes to Step 5; and
Case 2: if no group of parameters (i, j, and Δ) satisfying the relation in the formula (9) is found,
j=j+2;
if j<n (that is, j does not exceed the viewing zone i), the process goes to Step 3; and
if j≧n (that is, j already exceeds the viewing zone i),
i=i+1; and
j=0;
if i≦iₘₐₓ, the process goes to Step 3;
if i>iₘₐₓ, it indicates that the viewing position departs from the range of the optimum viewable plane, and the process goes to Step 5;
Step 5: ending comparison;
where the parameters are defined as follows:
xₘₐₓ and yₘₐₓ: the ranges of the optimum viewable plane;
iₘₐₓ: the index of the largest horizontal viewing zone corresponding to the optimum viewable plane;
i: a horizontal viewing zone number;
j: a view number;
n: a total view number;
m: the number of sub-pixels in a horizontal smallest display unit;
Δ: a horizontal displacement phase; and
L_{H}: a horizontal interval between two optimum viewing points.

28. The method of displaying a 3D image according to claim 1, wherein the procedure of aligning a viewing point and a view comprises the following steps when the position of the right eye is used as a reference:
Step 1: verifying whether the positions of the left and right eyes (X_{L},Y_{E},Z₀) and (X_{R},Y_{E},Z₀) are within the range of the optimum viewable plane, wherein if the relation in the following formulas is satisfied, the process goes to Step 2; and if the relation of the following formula is not satisfied, it indicates that the viewing position departs from the range of the optimum viewable plane, and the process goes to Step 5;

|X_{L}|≦xₘₐₓ;

|X_{R}|≦xₘₐₓ; and

|Y_{E}|≦yₘₐₓ;
Step 2: setting an initial value, as shown in the following formula:
i=−iₘₐₓ; and
j=1;
Step 3: calculating x(i,j,Δ);
Step 4: comparing x_{R0} and x(i,j,Δ), as shown in the following formula:

|x_{R0}−x(i,j,Δ)|≦L_{H}/2m (10),
Case 1: if a group of parameters (i, j, and Δ) satisfying the relation of the formula (10) are found, substitute A in the formula (1) or (2), and it indicates that the 3D eye tracking is successful, and the process goes to Step 5;
Case 2: if no group of parameters (i, j, and Δ) meeting the relation of the formula (10) is found,
j=j+2;
if j<n (that is, j does not exceed the viewing zone i), the process goes to Step 3; and
if j≧n (that is, j already exceeds the viewing zone i),
i=i+1; and
j=1;
if i≦iₘₐₓ, the process goes to Step 3; and
if i>iₘₐₓ, it indicates that the viewing position departs from the range of the optimum viewable plane, and the process goes to Step 5;
Step 5: ending comparison,
where the parameters are defined as follows:
xₘₐₓ and yₘₐₓ: the ranges of the optimum viewable plane;
iₘₐₓ: the index of the largest horizontal viewing zone corresponding to the optimum viewable plane;
i: a horizontal viewing zone number;
j: a view number;
n: a total view number;
m: the number of sub-pixels in a horizontal smallest display unit;
Δ: a horizontal displacement phase; and
L_{H}: a horizontal interval between two optimum viewing points.

29. The method of displaying a 3D image according to claim 1, wherein the optimum viewable plane refers to that a viewable plane with a limited area exists on the optimum viewing plane, only multiple optimum viewing points with a limited number exist on the plane, the multiple optimum viewing points respectively provide a single view image with a low ghost image and approximate image brightness for the left and right eyes, the plane formed of the optimum viewing points with the limited number is the optimum viewable plane, and coordinate values of x and y of any arbitrary position on the optimum viewable plane have the following relation:
−xₘₐₓ≦x≦xₘₐₓ; and
−yₘₐₓ≦y≦yₘₐₓ,
where xₘₐₓ and yₘₐₓ specify the range of the optimum viewable plane; in addition, on the optimum viewing plane, through practical measurement of cross-talk and brightness of the 3D image, values of the xₘₐₓ and yₘₐₓ are obtained; and according to xₘₐₓ and yₘₐₓ, a horizontal viewable angle Ω_{H} and a vertical viewable angle Ω_{V} are also obtained through calculation with the following formulas:
Ω_{H}=2×tan⁻¹(xₘₐₓ/Z₀); and
Ω_{V}=2×tan⁻¹(yₘₐₓ/Z₀),
where Z₀ is an optimum viewing distance; and the values of xₘₐₓ and yₘₐₓ also respectively correspond to iₘₐₓ and kₘₐₓ, so that an optimum viewable point P_{k,i,j} exists on an optimum viewable plane, and the horizontal viewing zone number i and the vertical viewing zone number k in P_{k,i,j} have the following relation:

|i|≦iₘₐₓ; and

|k|≦kₘₐₓ,
where the following relation exists between xₘₐₓ and iₘₐₓ and between yₘₐₓ and kₘₐₓ:
xₘₐₓ=iₘₐₓ×n×L_{E}; and
yₘₐₓ=kₘₐₓ×L_{V}.
